(19) United States
(12) Patent Application Publication
(10) Pub. No.: US 2026/0181315 A1
(43) Pub. Date: Jun. 25, 2026

(54) ACOUSTIC SIGNAL OUTPUT DEVICE

(71) Applicant: NTT , Inc, Tokyo (JP)

(72) Inventors: Tatsuya KAKO, Musashino-shi, Tokyo (JP); Hironobu CHIBA, Musashino-shi, Tokyo (JP)

(73) Assignee: NTT , Inc, Tokyo (JP)

(21) Appl. No.: 19/126,651

(22) PCT Filed: Nov. 10, 2022
(86) PCT No.: PCT/JP2022/041805

§ 371 Date: May 2, 2025

(51) Int. Cl. H04R 1/34; H04R 1/10; H04R 1/24; H04R 3/12

(52) U.S. Cl. CPC H04R 1/345; H04R 1/1075; H04R 1/24; H04R 3/12

(57) ABSTRACT

An acoustic signal output device including a concave reflector that has a rotational paraboloid or a surface approximate to the rotational paraboloid inside, and a first driver unit that is disposed inside the reflector. A first acoustic signal is emitted from the first driver unit to one side, and the second acoustic signal is emitted from the other side. An attenuation rate of the first acoustic signal at a second point that is based on a predetermined first point where the first acoustic signal arrives and is more distant from the acoustic signal output device than the first point is less than or equal to a predetermined value smaller than an attenuation rate caused by air propagation of an acoustic signal at the second point based on the first point.

### TECHNICAL FIELD

The present invention relates to an acoustic signal output device, and particularly relates to an acoustic signal output device that does not seal ear canals.

### BACKGROUND ART

In recent years, an increase in burden on ears due to wearing of earphones and headphones has been an issue. As devices that reduce the burden on ears, open-ear (open-type) earphones and headphones that do not block ear canals are known.

### CITATION LIST

### Non Patent Literature

Non Patent Literature 1: “WHAT ARE OPEN-EAR HEADPHONES?”, [online], Bose Corporation, [retrieved on Sep. 7, 2022], Internet <https://www.bose.com/en_us/better_with_bose/open-ear-headphones.html>

### SUMMARY OF INVENTION

### Technical Problem

However, open-ear earphones and headphones have an issue that sound leakage to the surroundings is large. Such an issue is not limited to the open-ear earphones and headphones, but is an issue common to acoustic signal output devices that include an installation speaker and a built-in speaker and do not seal ear canals.

The present invention has been made in view of such a point, and an object of the present invention is to provide an acoustic signal output device that does not seal ear canals and is capable of reducing sound leakage to the surroundings.

### Solution to Problem

Provided is an acoustic signal output device including a concave reflector that has a rotational paraboloid or a surface approximate to the rotational paraboloid inside, and a first driver unit that is disposed inside the reflector. Here, an acoustic signal emitted from the first driver unit to one side is a first acoustic signal, and an acoustic signal emitted from the first driver unit to the other side is a second acoustic signal. The acoustic signal output device is designed such that in a case where the first acoustic signal is emitted from one side of the first driver unit and the second acoustic signal is emitted from the other side of the first driver unit, an attenuation rate of the first acoustic signal at a second point that is based on a predetermined first point where the first acoustic signal arrives and is more distant from the acoustic signal output device than the first point is less than or equal to a predetermined value smaller than an attenuation rate caused by air propagation of an acoustic signal at the second point based on the first point. Alternatively, in this case, the acoustic signal output device is designed such that an attenuation amount of the first acoustic signal at the second point based on the first point is larger than or equal to a predetermined value larger than an attenuation amount caused by air propagation of the acoustic signal at the second point based on the first point.

### Advantageous Effects of Invention

With this structure, the sound leakage to the surroundings can be suppressed.

### BRIEF DESCRIPTION OF DRAWINGS

FIG. 1 is a transparent front view illustrating a configuration of an acoustic signal output device according to a first embodiment.

FIG. 2 is a transparent plan view illustrating a configuration of an acoustic signal output device according to the first embodiment.

FIG. 3 is a cross-sectional view taken along line 1-1 of FIG. 1.

FIG. 4 is a cross-sectional view taken along line 2-2 of FIG. 2.

FIG. 5 is a conceptual diagram for illustrating arrangement of sound holes.

FIG. 6 is a conceptual diagram for describing a relationship between a rotational paraboloid and a focal point.

FIG. 7A is a conceptual diagram for describing a traveling direction of an acoustic signal in a case where a driver unit is disposed at a focal point of a rotational paraboloid. FIG. 7B is a conceptual diagram for describing a traveling direction of an acoustic signal in a case where a driver unit is not disposed at a focal point of a rotational paraboloid.

FIG. 8A is a conceptual diagram illustrating a configuration in which a horn is attached to a driver unit.

FIG. 8B is a conceptual diagram for illustrating an arrangement configuration of an acoustic signal output device according to the first embodiment.

FIG. 9A is a block diagram illustrating a functional configuration in which a signal is supplied to a driver unit. FIG. 9B is a diagram illustrating a sound pressure level at a measurement point.

FIGS. 10A and 10B are graphs for illustrating directional characteristics of an acoustic signal output device.

FIGS. 11A and 11B are graphs for illustrating directional characteristics of an acoustic signal output device.

FIG. 12 is a graph for illustrating directional characteristics of an acoustic signal output device.

FIGS. 13A and 13B are graphs for illustrating frequency characteristics of an acoustic signal output device.

FIGS. 14A and 14B are graphs for illustrating frequency characteristics of an acoustic signal output device.

FIG. 15 is a graph for illustrating frequency characteristics of an acoustic signal output device.

FIG. 16 is a front view for illustrating a modification example of arrangement of sound holes.

FIG. 17 is a front view for illustrating a modification example of arrangement of sound holes.

FIG. 18 is a transparent front view illustrating a configuration of an acoustic signal output device according to a modification example of the first embodiment.

FIG. 19 is a transparent plan view illustrating a configuration of an acoustic signal output device according to the modification example of the first embodiment.

FIG. 20A is a transparent plan view illustrating a configuration of a housing according to the modification example of the first embodiment. FIG. 20B is a transparent front view illustrating a configuration of a housing according to the modification example of the first embodiment. FIG. 20C is a bottom view illustrating a configuration of a housing according to the modification example of the first embodiment.

FIG. 21 is a cross-sectional view taken along line 19-19 of FIG. 19.

FIGS. 22A and 22B are cross-sectional views for illustrating a configuration of an acoustic signal output device according to the modification example of the first embodiment.

FIG. 23 is a transparent front view illustrating a configuration of an acoustic signal output device according to a second embodiment.

FIG. 24 is a transparent plan view illustrating a configuration of an acoustic signal output device according to the second embodiment.

FIG. 25 is a transparent front view illustrating a configuration of an acoustic signal output device according to a modification example of the second embodiment.

FIG. 26 is a transparent front view illustrating a configuration of an acoustic signal output device according to the modification example of the second embodiment.

FIG. 27A is a graph for illustrating frequency characteristics of an acoustic signal measured on a cutout portion side. FIG. 27B is a graph for illustrating frequency characteristics of an acoustic signal measured on a side where a cutout portion is not provided.

FIG. 28A is a graph for illustrating frequency characteristics of an acoustic signal measured on a cutout portion side and on a side where a cutout portion is not provided. FIG. 28B is a graph for illustrating a difference of frequency characteristics of an acoustic signal, caused by a difference of a cutout portion side.

FIG. 29 is a transparent front view illustrating a configuration of an acoustic signal output device according to a third embodiment.

FIG. 30A is a block diagram illustrating a functional configuration in which a signal is supplied to a driver unit. FIG. 30B is a diagram illustrating a sound pressure level at a measurement point.

### DESCRIPTION OF EMBODIMENTS

Hereinafter, embodiments of the present invention will be described with reference to the drawings.

### First Embodiment

First, a first embodiment of the present invention will be described.

### <Configuration>

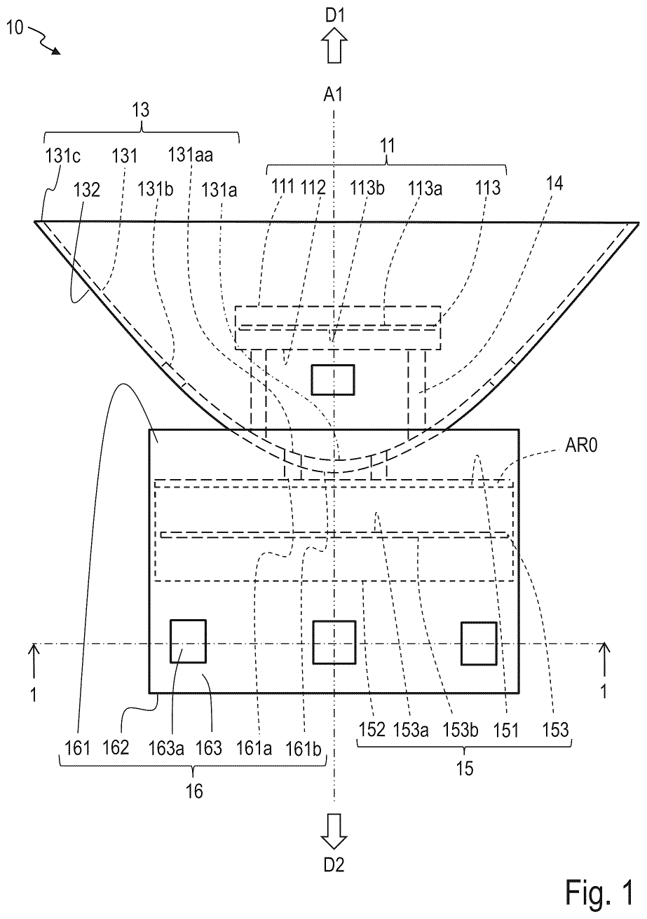

An acoustic signal output device 10 of the present embodiment is an acoustic listening device (for example, open-ear (open-type) earphones, headphones, an installation speaker, a built-in speaker, or the like) that is worn without sealing the ear canals of a user. As illustrated in FIGS. 1 to 4, the acoustic signal output device 10 of the present embodiment includes a concave (for example, a parabolic) reflector 13 that has a rotational paraboloid or a surface approximate to the rotational paraboloid inside, driver units 11 and 15 (a speaker driver unit and a driver) that convert an output signal (an electric signal representing an acoustic signal) output from a reproduction device into an acoustic signal and output the acoustic signal, a housing 16 that accommodates the driver unit 15 therein, and a support portion 14 for disposing the driver unit 11 inside the reflector 13.

### <Driver Unit 11 (First Driver Unit)>

In the present embodiment, the frequency band of the acoustic signal to be reproduced (reproduced acoustic signal) is divided into a high frequency band and a low frequency band, and the driver unit 11 emits the acoustic signal on the high frequency band side among the reproduced acoustic signals. That is, the driver unit 11 mainly handles a high-frequency acoustic signal among the reproduced acoustic signals. The output signal output from the reproduction device is separated into a high frequency band signal on a high-frequency side and a low frequency band signal on a low-frequency side, which is lower than the high frequency band signal, and the separated high frequency band signal is input to the driver unit 11. Note that the frequency bands in which the level of the high frequency band signal and the level of the low frequency band signal are greater than or equal to a predetermined value may overlap each other or may not overlap each other. The driver unit 11 is a device (device having a speaker function) that emits (emits sound of) an acoustic signal AC1 (first acoustic signal) based on an input high frequency band signal to one side (D1 direction side), and emits an acoustic signal AC2 (second acoustic signal) that is an antiphase signal (phase inversion signal) of the acoustic signal AC1 or an approximate signal of the antiphase signal to the other side (D2 direction side). That is, an acoustic signal emitted from the driver unit 11 to one side (D1 direction side) is referred to as the acoustic signal AC1 (first acoustic signal), and an acoustic signal emitted from the driver unit 11 to the other side (D2 direction side) is referred to as the acoustic signal AC2 (second acoustic signal). For example, the driver unit 11 is disposed on an axis A1 extending along the D1 direction or near the axis A1, and the acoustic signals AC1 and AC2 are emitted along the axis A1. For example, the driver unit 11 includes a diaphragm 113 that emits the acoustic signal AC1 from one surface 113a to the D1 direction side by vibration and emits the acoustic signal AC2 from the other surface 113b to the D2 direction side by the vibration (FIG. 1). For example, the diaphragm 113 is disposed on the axis A1 or near the axis A1. When the diaphragm 113 vibrates on the basis of the input high frequency band signal, the driver unit 11 of this example emits the acoustic signal AC1 from one-side surface 111 to the D1 direction side and emits the acoustic signal AC2 that is an antiphase signal of the acoustic signal AC1 or an approximate signal of the antiphase signal from the other side surface 112 to the D2 direction side. That is, the acoustic signal AC2 is secondarily emitted along with emission of the acoustic signal AC1. Note that the D2 direction (the other side) is, for example, the opposite direction of the D1 direction (one side), but the D2 direction does not need to be strictly the opposite direction of the D1 direction, and the D2 direction is only required to be different from the D1 direction. The relationship between one side (D1 direction) and the other side (D2 direction) depends on the type and shape of the driver unit 11. Furthermore, depending on the type and shape of the driver unit 11, the acoustic signal AC2 may strictly be an antiphase signal of the acoustic signal AC1, or the acoustic signal AC2 may be an approximate signal of the antiphase signal of the acoustic signal AC1. For example, the approximate signal of the antiphase signal of the acoustic signal AC1 may be (1) a signal obtained by shifting a phase of the antiphase signal of the acoustic signal AC1, (2) a signal obtained by changing (amplifying or attenuating) an amplitude of the antiphase signal of the acoustic signal AC1, or (3) a signal obtained by shifting the phase of the antiphase signal of the acoustic signal AC1 and further changing the amplitude. A phase difference between the antiphase signal of the acoustic signal AC1 and the approximate signal thereof is desirably smaller than or equal to 81% of one period of the antiphase signal of the acoustic signal AC1. Examples of 81% include 1%, 3%, 5%, 10%, and 20%. Furthermore, a difference between the amplitude of the antiphase signal of the acoustic signal AC1 and the amplitude of the approximate signal thereof is desirably smaller than or equal to 82% of the amplitude of the antiphase signal of the acoustic signal AC1. Examples of 82% include 18, 38, 5%, 10%, and 20%. Note that examples of the type of the driver unit 11 include a dynamic type, a balanced armature type, a hybrid type of the dynamic type and the balanced armature type, and a capacitor type. Furthermore, the shapes of the driver unit 11 and the diaphragm 113 are not limited. In the present embodiment, for simplification of description, an example in which the outer shape of the driver unit 11 is a substantially cylindrical shape including opposite end surfaces and the diaphragm 113 is a substantially disk shape is described, but this does not limit the present invention. For example, the outer shape of the driver unit 11 may be a rectangular parallelepiped shape or the like, and the diaphragm 113 may have a dome shape or the like. Furthermore, examples of the acoustic signal include sounds such as music, voice, a sound effect, and environmental sound.

### <Driver Unit 15 (Second Driver Unit)>

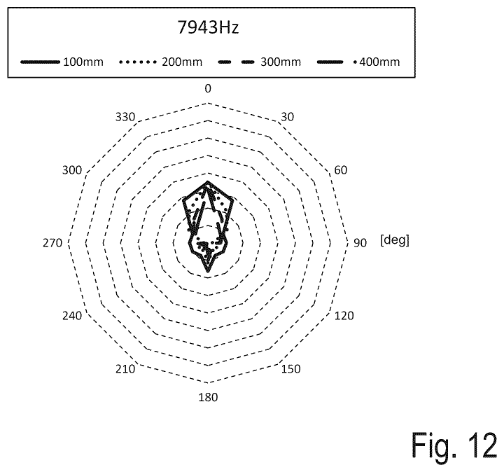

The driver unit 15 of the present embodiment is disposed on the D2 direction side of the driver unit 11. The driver unit 15 is larger in size than the driver unit 11 and emits the acoustic signal on the low frequency band side among the reproduced acoustic signals described above. That is, the driver unit 15 mainly handles a low-frequency acoustic signal among the reproduced acoustic signals. Thus, a low frequency sound pressure can be obtained as compared with a case where only the driver unit 11 is used. As described above, the low frequency band signal separated from the output signal is input to the driver unit 15, and the driver unit 15 is a device (device including a speaker function) that emits (emits sound of) an acoustic signal AC3 (third acoustic signal) based on the input low frequency band signal to one side (D1 direction side), and emits an acoustic signal AC4 (fourth acoustic signal) that is an antiphase signal (phase inversion signal) of the acoustic signal AC3 or an approximate signal of the antiphase signal to the other side (D2 direction side). That is, the acoustic signal emitted from the driver unit 15 to one side (D1 direction side) is referred to as the acoustic signal AC3 (third acoustic signal), and the acoustic signal emitted from the driver unit 15 to the other side (D2 direction side) is referred to as the acoustic signal AC4 (fourth acoustic signal). For example, the driver unit 15 is disposed on the axis A1 or near the axis A1, and the acoustic signals AC3 and AC4 are emitted along the axis A1. The driver unit 15 includes a diaphragm 153 (second diaphragm) that emits the acoustic signal AC3 (third acoustic signal) from one surface 153a to the D1 direction side (one side) by vibration and emits the acoustic signal AC4 (fourth acoustic signal) from the other surface 153b to the D2 direction side (the other side) by the vibration (FIG. 12). For example, the diaphragm 153 is disposed on the axis A1 or near the axis A1. When the diaphragm 153 vibrates on the basis of the input low frequency band signal, the driver unit 15 of this example emits the acoustic signal AC3 from one-side surface 151 to the D1 direction side and emits the acoustic signal AC4 that is an antiphase signal of the acoustic signal AC3 or an approximate signal of the antiphase signal from the other side surface 152 to the D2 direction side. That is, the acoustic signal AC4 is secondarily emitted along with emission of the acoustic signal AC3. The acoustic signal AC3 is an in-phase signal of the acoustic signal AC1 or an approximate signal of the in-phase signal, and the acoustic signal AC4 is an in-phase signal of the acoustic signal AC2 or an approximate signal of the in-phase signal. Note that, depending on the type and shape of the driver unit 15, the acoustic signal AC4 may strictly be an antiphase signal of the acoustic signal AC3, or the acoustic signal AC4 may be an approximate signal of the antiphase signal of the acoustic signal AC3. For example, the approximate signal of the antiphase signal of the acoustic signal AC3 may be (1) a signal obtained by shifting a phase of the antiphase signal of the acoustic signal AC3, (2) a signal obtained by changing (amplifying or attenuating) an amplitude of the antiphase signal of the acoustic signal AC3, or (3) a signal obtained by shifting the phase of the antiphase signal of the acoustic signal AC3 and further changing the amplitude. A phase difference between the antiphase signal of the acoustic signal AC3 and the approximate signal thereof is desirably smaller than or equal to 83% of one period of the antiphase signal of the acoustic signal AC3. Examples of 83% include 1%, 3%, 5%, 10%, and 20%. Furthermore, a difference between the amplitude of the antiphase signal of the acoustic signal AC3 and the amplitude of the approximate signal thereof is desirably smaller than or equal to 84% of the amplitude of the antiphase signal of the acoustic signal AC3. Examples of 84% include 1%, 3%, 5%, 10%, and 20%. Note that examples of the type of the driver unit 15 include a dynamic type, a balanced armature type, a hybrid type of the dynamic type and the balanced armature type, and a capacitor type. Furthermore, the shapes of the driver unit 15 and the diaphragm 153 are not limited. In the present embodiment, for simplification of description, an example in which the outer shape of the driver unit 15 is a substantially cylindrical shape including opposite end surfaces and the diaphragm 153 is a substantially disk shape is described, but this does not limit the present invention. For example, the outer shape of the driver unit 15 may be a rectangular parallelepiped shape or the like, and the diaphragm 153 may have a dome shape or the like.

As described above, the driver unit 15 is larger in size than the driver unit 11. For example, assuming that the diameter of the driver unit 11 (the diameter in a direction orthogonal to the D1 direction and/or the D2 direction) is set to S11 and the diameter of the driver unit 15 (the diameter in a direction orthogonal to the D1 direction and/or the D2 direction) is set to S21, S21>S11 is satisfied. For example, S21 is greater than or equal to twice S11, S11 is 12 mm, and S21 is 35 mm. Furthermore, for example, assuming that the diameter of the diaphragm 113 (the diameter in a direction orthogonal to the D1 direction and/or the D2 direction) is set to S12 and the diameter of the diaphragm 153 (the diameter in a direction orthogonal to the D1 direction and/or the D2 direction) is set to S22, S22>S12 is satisfied. For example, S22 is greater than or equal to twice S12, S12 is 10 mm, and S22 is 30 mm. That is, the diameter of the diaphragm 153 (second diaphragm) is larger than the diameter of the diaphragm 113 (first diaphragm).

### <Reflector 13 and Support Portion 14>

The reflector 13 is a concave structure having a rotational paraboloid or a surface approximate to the rotational paraboloid inside. That is, at least a part of the inner wall surface 131 of the reflector 13 is a rotational paraboloid or a surface approximate to the rotational paraboloid. This rotational paraboloid has, for example, a shape formed by rotating a parabola about the axis A1 (specific axis). The entire inner wall surface 131 may be a rotational paraboloid or a surface approximate to the rotational paraboloid, or only a part of the inner wall surface 131 (for example, only the inner wall surface 131 on a bottom portion 131a side or only the inner wall surface 131 on a distal end portion 131c side of the reflector 13) may be a rotational paraboloid or a surface approximate to the rotational paraboloid.

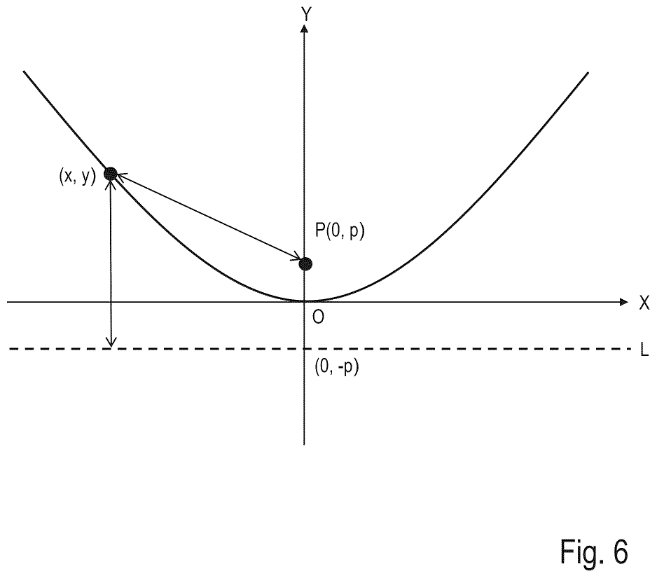

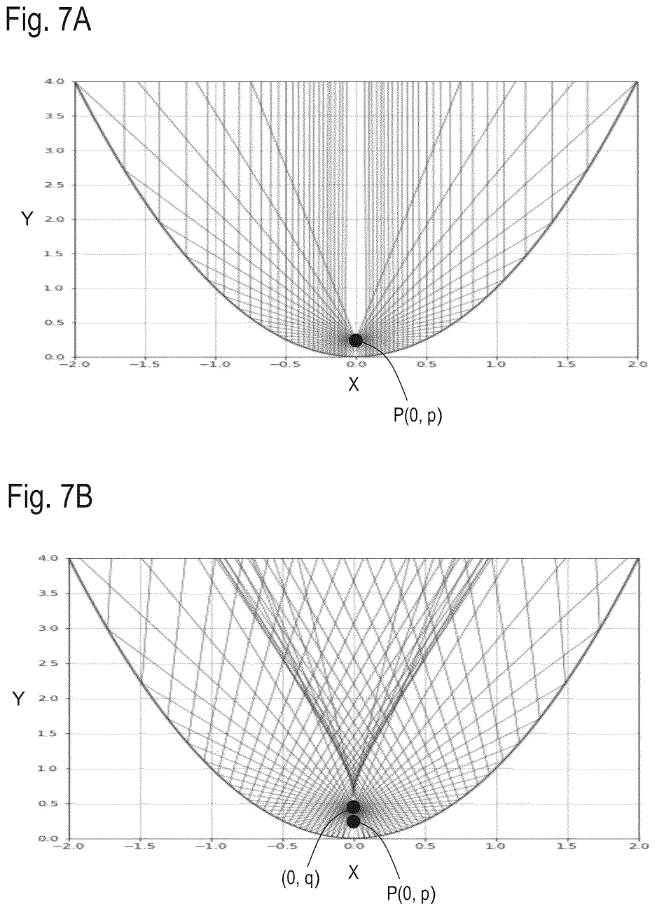

The driver unit 11 is disposed inside the reflector 13. The driver unit 11 is fixed to the inner wall surface 131 of the reflector 13 via the support portion 14. In the present embodiment, one surface 111 of the driver unit 11 disposed inside the reflector 13 is directed to the open end 130 side (D1 direction side) of the reflector 13, and the other side surface 112 is directed to the bottom portion 131a side (D2 direction side) of the reflector 13. The driver unit 11 (first driver unit) emits the acoustic signal AC1 (first acoustic signal) to the D1 direction side (one side) of the driver unit 11, and emits the acoustic signal AC2 (second acoustic signal) to the D2 direction side (the other side) of the driver unit 11. The acoustic signal AC1 (reproduced acoustic signal) emitted from the driver unit 11 is emitted outward from the open end 130 on the D1 direction side of the reflector 13. Here, a part of the acoustic signal AC1 is emitted from the driver unit 11 directly to the D1 direction side of the reflector 13. Furthermore, at least another part of the acoustic signal AC1 is reflected by the inner wall surface 131 of the reflector 13 and then emitted from the open end 130 to the D1 direction side. Furthermore, at least a part of the acoustic signal AC2 is reflected by the inner wall surface 131 of the reflector 13 and then emitted from the open end 130 to the D1 direction side. A user located on the D1 direction side can listen to the acoustic signal AC1 emitted from the open end 130 of the reflector 13. At this time, the reflector 13 suppresses sound leakage of the acoustic signal AC1 to a back surface 132 side of the reflector 13. Furthermore, the acoustic signal AC2 is an antiphase signal of the acoustic signal AC1 or an approximate signal of the antiphase signal. Therefore, at a specific position (for example, a position behind the user) on the D1 direction side other than the position where the user is present, a part of the acoustic signal AC1 cancels out a part of the acoustic signal AC2, and the sound leakage of the acoustic signal AC1 is suppressed. Note that the driver unit 11 is desirably disposed on the axis A1, for example, the diaphragm 113 is desirably disposed on the axis A1. More preferably, the center of the diaphragm 113 or the vicinity of the diaphragm 113 is desirably disposed on the axis A1. In other words, it is desirable that the diaphragm 113 is disposed at the center or near the center of the rotational paraboloid described above. Thus, the sound pressure of the acoustic signal AC1 emitted from the open end 130 is axially symmetric to or substantially axially symmetric to the axis A1. Furthermore, more preferably, the driver unit 11 is disposed at or near the focal point of the rotational paraboloid. In this case, the directivity of the acoustic signal AC1 emitted from the open end 130 is enhanced. Details will be described below. As illustrated in FIG. 6, on X-Y coordinates, a point on a parabola forming the rotational paraboloid is defined as (x, y), a focal point of the rotational paraboloid is defined as P (0, p), and a directrix parallel to an X axis passing through a point (0, −p) is defined as L: y=−p. Here, p≠0. In this case, a set of points (x, y) having the same distance from the focal point P(0, p) and the directrix L: y=−p satisfies x²=4py. As illustrated in FIG. 7A, in a case where the driver unit 11 is disposed at the focal point P(0, p) or in the vicinity of the focal point P(0, p) of the rotational paraboloid, the center in the traveling direction of the acoustic signal AC1 emitted from the open end 130 is parallel to the Y axis (axis A1). Therefore, when the driver unit 11 is disposed at the focal point P(0, p) or in the vicinity of the focal point P(0, p) of the rotational paraboloid, the directivity of the acoustic signal AC1 emitted from the open end 130 is enhanced. On the other hand, as illustrated in FIG. 7B, in a case where the driver unit 11 is disposed at the focal point P(0, p) or a position (0, q) deviated from the vicinity of the focal point P(0, p) of the rotational paraboloid (p≠q), the center in the traveling direction of the acoustic signal AC1 emitted from the open end 130 spreads outward with respect to the Y axis. In this case, as compared with the case where the driver unit 11 is disposed at the focal point P(0, p) or in the vicinity of the focal point P(0, p) of the rotational paraboloid, the directivity of the acoustic signal AC1 emitted from the reflector 13 is lower.

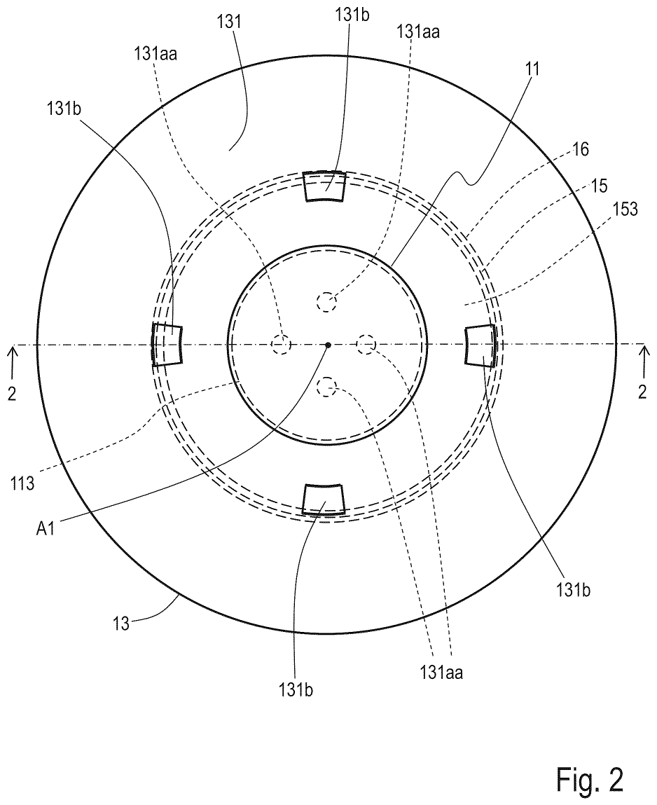

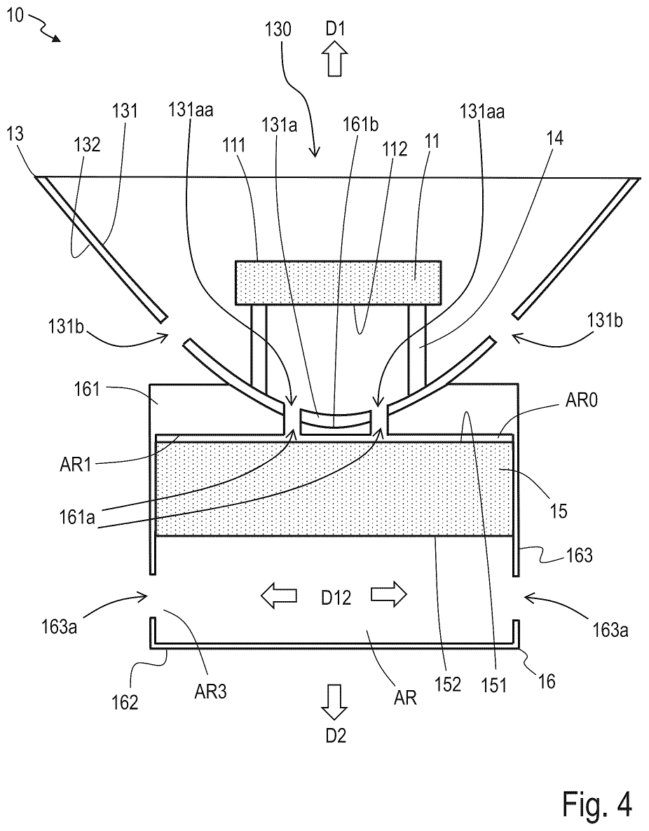

The acoustic signals AC1 and AC2 have shorter wavelengths and higher straightness as the frequency is higher. Therefore, the directivity of the high-frequency components of the acoustic signals AC1 and AC2 emitted from the open end 130 of the reflector 13 is high, and the high-frequency components hardly leak to the back surface 132 side of the reflector 13. Here, a part of the acoustic signal AC2 is reflected by the inner wall surface 131 of the reflector 13 and then emitted from the open end 130 to the D1 direction side. The acoustic signal AC2 is an antiphase signal of the acoustic signal AC1 or an approximate signal of the antiphase signal. However, these high-frequency components have a short wavelength and are difficult to cancel out each other. Therefore, on the D1 direction side, the sound pressure of the high-frequency component of the acoustic signal AC1 can be sufficiently secured. On the other hand, the directivity of the medium and low frequency components of the acoustic signals AC1 and AC2 emitted from the open end 130 is low, and the acoustic signals AC1 and AC2 easily leak to the back surface 132 side. However, the acoustic signal AC2 is an antiphase signal of the acoustic signal AC1 or an approximate signal of the antiphase signal, and these low frequency components have a long wavelength and are likely to cancel out each other. Therefore, even when the low frequency components of the acoustic signals AC1 and AC2 leak to the back surface 132 side, the low frequency components cancel out each other, and thus the sound leakage can be suppressed. In order for the acoustic signal AC2 to cancel out the acoustic signal AC1 at the position where sound leakage is to be suppressed, it is ideal that a difference between the propagation distance from one-side surface 111 of the driver unit 11 to the position where sound leakage is to be suppressed and the propagation distance from the other side surface 112 of the driver unit 11 to the position where sound leakage is to be suppressed is an integral multiple (including a case of being equal to the wavelengths) of the wavelengths of the acoustic signals AC1 and AC2. In order to optimize this condition, the reflector 13 of the present embodiment is provided with one or a plurality of sound holes 131b (reflector sound holes). Thus, the sound leakage of the medium and low frequency components of the acoustic signals AC1 and AC2 can be suppressed. Furthermore, the sound hole 131b also has a function of weakening the directivity of the high-frequency components of the acoustic signals AC1 and AC2. When the sound pressure of the high-frequency component is too high, it may be felt unpleasant. However, by providing the sound hole 131b, the sound pressure of the high-frequency components of the acoustic signals AC1 and AC2 emitted to the D1 direction side can be weakened. Note that FIG. 2 and the like illustrate an example in which four rectangular sound holes 131b are disposed in the reflector 13 in axial symmetry or substantially axial symmetry with respect to the axis A1. However, this does not limit the present invention, and sound hole 131b having a circular shape, a triangular shape, or the like may be provided, a plurality of the sound holes 131b having different shapes and sizes may be provided, or the sound holes 131b may be disposed eccentrically at any position. For example, the sound holes 131b may be disposed eccentrically in a direction in which sound leakage of the acoustic signal AC1 becomes a problem. Furthermore, as illustrated in FIGS. 1, 4, and the like, the sound holes 131b are desirably disposed on the D2 direction side (the other side) of the driver unit 11 (first driver unit) or in the vicinity of the D2 direction side (the) of the driver unit 11 (first driver unit). Thus, the acoustic signal AC1 emitted from the D1 direction side of the driver unit 11 is less likely to be emitted from the sound holes 131b, and the acoustic signal AC2 emitted from the D2 direction side of the driver unit 11 is likely to be emitted from the sound holes 131b. As a result, the difference in propagation distance between the acoustic signal AC1 and the acoustic signal AC2, which is described above, can be easily adjusted depending on the size, number, arrangement, and the like of the sound hole 131b. Note that the sound holes 131b are sound holes penetrating the reflector 13, but the present invention is not limited thereto. As long as the acoustic signal inside the reflector 13 can be led out to the outside, the sound holes 131b may not be through holes. Here, for simplicity of description, a case where the shape of the edges of the open ends of the sound holes 131b is a quadrangle (the case where the open ends are rectangles) is described, but this does not limit the present invention. For example, the shape of the edge of the open end of the sound hole 131b may be another shape such as a circle, an ellipse, and a triangle. Furthermore, the open end of the sound hole 131b may have a mesh shape.

With the configuration described above, when the acoustic signal AC1 (first acoustic signal) is emitted from the D1 direction side (one side) of the driver unit 11 (first driver unit) and the acoustic signal AC2 (second acoustic signal) is emitted from the D2 direction side (the other side) of the driver unit 11 (first driver unit), an attenuation rate nu of the acoustic signal AC1 (first acoustic signal) at a position P2 (second point) with reference to a position P1 (first point) can be set to be smaller than or equal to a predetermined value ηₜₕ, or an attenuation amount η₁₂ of the acoustic signal AC1 (first acoustic signal) at the position P2 (second point) with reference to the position P1 (first point) can be set to be larger than or equal to a predetermined value ωₜₕ. Here, the position P1 (first point) is a predetermined point where the acoustic signal AC1 (first acoustic signal) reaches. On the other hand, the position P2 (second point) is a predetermined point whose distance from the acoustic signal output device 10 is longer than the position P1 (first point). The predetermined value ηₜₕ is a value smaller (value lower) than an attenuation rate η₂₁ of any or specific acoustic signal (sound) due to air propagation at the position P2 (second point) with reference to the position P1 (first point). Furthermore, the predetermined value ωₜₕ is a value larger than an attenuation amount η₂₂ of any or specific acoustic signal (sound) due to air propagation at the position P2 (second point) with reference to the position P1 (first point). That is, the acoustic signal output device 10 is designed such that the attenuation rate nu is smaller than or equal to the predetermined value ηₜₕ smaller than the attenuation rate η₂₁ or such that the attenuation amount η₁₂ is larger than or equal to the predetermined value ωₜₕ larger than the attenuation amount η₂₂. Note that the acoustic signal AC1 is propagated in air from the position P1 to the position P2 and is attenuated due to air propagation and the acoustic signal AC2. The attenuation rate η₁₁ is a ratio (AMP₂(AC1)/AMP₁(AC1)) of a magnitude AMP₂(AC1) of the acoustic signal AC1 at the position P2 attenuated due to air propagation and the acoustic signal AC2 to a magnitude AMP₁(AC1) of the acoustic signal AC1 at the position P1. Furthermore, the attenuation amount η₁₂ is a difference (|AMP₁(AC1)-AMP₂(AC1)|) between the magnitude AMP₁(AC1) and the magnitude AMP₂(AC1). On the other hand, in a case where the acoustic signal AC2 is not assumed, any or specific acoustic signal ACₐᵣ propagating in air from the position P1 to the position P2 attenuates not due to the acoustic signal AC2 but due to the air propagation. The attenuation rate η₂₁ is a ratio (AMP₂(ACₐᵣ)/AMP₁(ACₐᵣ)) of a magnitude AMP₂(ACₐᵣ) of the acoustic signal ACₐᵣ at the position P2 attenuated due to air propagation (attenuated not due to the acoustic signal AC2) to a magnitude AMP₁(ACₐᵣ) of the acoustic signal ACₐᵣ at the position P1. Furthermore, the attenuation amount η₂₂ is a difference (|AMP₁(ACₐᵣ)-AMP₂(ACₐᵣ)|) between the magnitude AMP₁(ACₐᵣ) and the magnitude AMP₂(ACₐᵣ). Note that an example of the magnitude of the acoustic signal is the sound pressure of the acoustic signal, energy of the acoustic signal, or the like. Furthermore, the “sound leakage component” means, for example, a component that is highly likely to arrive at a region (for example, a human other than the user present in the D1 direction) other than the user present in the D1 direction in the acoustic signal AC1 emitted from sound holes 161a. For example, the “sound leakage component” may be a component propagating to a region other than the specific region on the D1 direction side in the acoustic signal AC1, or may be a component propagating to a region other than the region on the D1 direction side.

Furthermore, as illustrated in FIGS. 1, 4, and the like, sound holes 131aa (reflector sound holes) connected to the internal space of the housing 16 are provided on the bottom portion 131a side (D2 direction side) of the reflector 13. The sound holes 131aa are sound holes penetrating the reflector 13, but the present invention is not limited thereto. As long as the acoustic signal in the internal space of the housing 16 can be led out to the inside of the reflector 13, the sound holes 131aa may not be through holes. Details of the sound holes 131aa will be described later.

The material of the reflector 13 is not limited, but at least the inner wall surface 131 is desirably made of a material that reflects the acoustic signal. For example, the reflector 13 may be formed of a rigid body such as synthetic resin or metal, or may be formed of an elastic body such as rubber.

### <Housing 16>

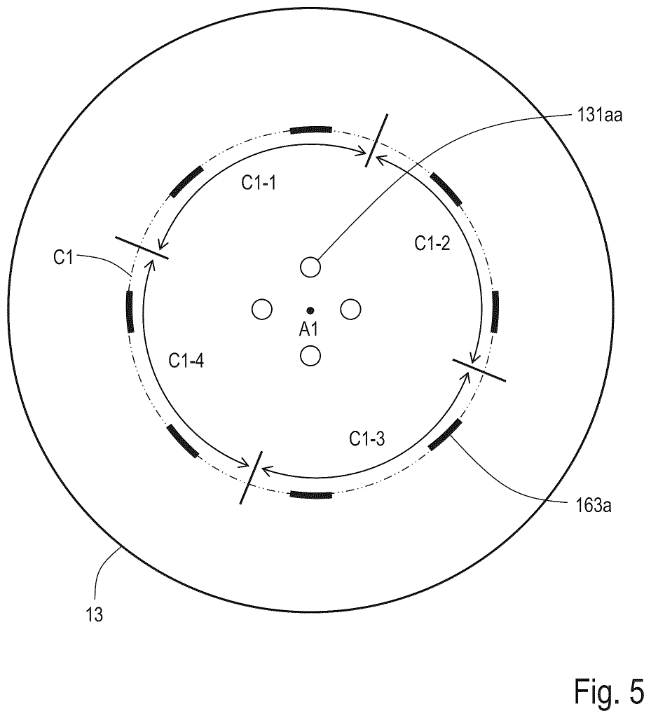

The housing 16 (second housing) is a hollow member having a wall portion outside, and is disposed outside the reflector 13. The housing 16 of the present embodiment is disposed on the D2 direction side of the reflector 13. The driver unit 15 (second driver unit) is accommodated in the housing 16. The driver unit 15 in this example is fixed at a position away from a wall portion 161 on the D1 direction side of the housing 16 by a certain distance. Thus, a hollow region AR0 is provided between a region AR1 inside the wall portion 161 of the housing 16 of this example and the surface 151 on the D1 direction side of the driver unit 15. The wall portion of the housing 16 include one or a plurality of the sound holes 161a (third sound holes) for leading out the acoustic signal AC3 (third acoustic signal) emitted from the driver unit 15 to the inside of the reflector 13 via the sound holes 131aa and one or a plurality of sound holes 163a (fourth sound holes) for leading out the acoustic signal AC4 (fourth acoustic signal) emitted from the driver unit 15 to the outside of the reflector 13 outside the housing 16. In the example of the present embodiment, a recess 161b is provided outside the wall portion 161 on one side (D1 direction side) of the housing 16, and the outside of the bottom portion 131a of the reflector 13 is fixed to the recess 161b. The sound holes 161a (third sound holes) are provided on the recess 161b and are connected to the sound holes 131aa (reflector sound holes) of the reflector 13 (FIGS. 1 and 4). Thus, the acoustic signal AC3 emitted from the driver unit 15 to the region AR0 is led out to the inside of the reflector 13 through the sound holes 161a and the sound holes 131aa. The acoustic signal AC3 led out to the inside of the reflector 13 is emitted from the open end 130 of the reflector 13 to the D1 direction side. Note that the sound holes 131aa (reflector sound holes) connected to the sound holes 161a (third sound holes) or the center for a plurality of the sound holes 131aa (reflector sound holes) connected to one or a plurality of the sound holes 161a (third sound holes) is desirably disposed on the axis A1 or near the axis A1 (for example, FIG. 5). Thus, the sound pressure of the acoustic signal AC3 emitted from the open end 130 of the reflector 13 is axially symmetric to or substantially axially symmetric to the axis A1. Furthermore, the sound holes 163a face the external space on the back surface 132 side of the reflector 13, and the acoustic signal AC4 emitted to the hollow region AR (internal space) of the housing 16 on the D2 direction side of the driver unit 15 is led out to the outside of the reflector 13 through the sound holes 163a. As described above, the acoustic signal AC4 is an antiphase signal of the acoustic signal AC3 or an approximate signal of the antiphase signal. Furthermore, the acoustic signal AC3 is an in-phase signal of the acoustic signal AC1 or an approximate signal of the in-phase signal, and the acoustic signal AC4 is an in-phase signal of the acoustic signal AC2 or an approximate signal of the in-phase signal. Thus, at least a part of the acoustic signal AC4 emitted from each of the sound holes 163a cancels out at least a part of sound leakage components of the acoustic signals AC1 and AC3 emitted from the open end 130 of the reflector 13. Thus, the sound leakage, in particular, the sound leakage of the low-frequency side (acoustic signal AC3) can be suppressed. Note that the sound holes 161a and the sound holes 163a are, for example, through holes penetrating the wall portion of the housing 16, but the present invention is not limited thereto. As long as the acoustic signal AC3 can be led out to the inside of the reflector 13 and the acoustic signal AC4 can be led out to the outside of the reflector 13, the sound holes 161a and the sound holes 163a may not be through holes. Although the shape of the housing 16 is not limited, for example, the shape of the housing 16 is desirably rotationally symmetric (axially symmetric) or substantially rotationally symmetric to the axis A1. Thus, it is easy to provide the sound holes 163a so as to reduce variation in sound pressure in each direction of the acoustic signal AC4 emitted from the housing 16. As a result, the sound leakage can be easily reduced uniformly in each direction. For example, the housing 16 includes a wall portion 161 disposed on one side (D1 direction side) of the driver unit 15, a wall portion 162 disposed on the other side (D2 direction side) of the driver unit 15, and a wall portion 163 surrounding a space sandwiched between the wall portion 161 and the wall portion 162 with an axis A1 passing through the wall portion 161 and the wall portion 162 as the center (FIGS. 1 and 4). Here, for simplification of description, an example is described in which the housing 16 has a substantially cylindrical shape including opposite end surfaces. However, these are examples and do not limit the present invention. For example, the housing 16 may have a substantially dome shape including a wall portion at an end portion, may have a hollow substantially cubic shape, or may have another three-dimensional shape. Furthermore, the material of the housing 16 is not limited. The housing 16 may be formed of a rigid body such as synthetic resin or metal or may be formed of an elastic body such as rubber.

A user located in a specific region on the D1 direction side can listen to the acoustic signals AC1 and AC3 emitted from the open end 130 of the reflector 13. As described above, the acoustic signal AC2 that is an antiphase signal of the acoustic signal AC1 or an approximate signal of the antiphase signal is emitted from the sound holes 131b. Furthermore, the acoustic signal AC4 that is an antiphase signal of the acoustic signal AC3 or an approximate signal of the antiphase signal is emitted from the sound holes 163a. Here, a part of the emitted acoustic signals AC2 and AC4 cancels out a part of the acoustic signals AC1 and AC3 (sound leakage components) emitted from the open end 130 of the reflector 13. For example, a part of the acoustic signal AC2 mainly cancels out a part of the acoustic signal AC1, and a part of the acoustic signal AC4 mainly cancels out a part of the acoustic signal AC3. That is, the acoustic signal AC1 (first acoustic signal) is emitted from the D1 direction side (one side) of the driver unit 11 (first driver unit), the acoustic signal AC2 (second acoustic signal) is emitted from the D2 direction side (the other side) of the driver unit 11 (first driver unit), the acoustic signal AC3 (third acoustic signal) is emitted from the D1 direction side (one side) of the driver unit 15 (second driver unit), and the fourth acoustic signal is emitted from the D2 direction side (the other side) of the driver unit 15 (second driver unit). Therefore, attenuation rates η₁₁₂ of the acoustic signal AC1 (first acoustic signal) and the acoustic signal AC3 (third acoustic signal) at the position P2 (second point) with reference to the position P1 (first point) can be set to be smaller than or equal to a predetermined value ηₜₕ, or attenuation amounts η₁₂₂ of the acoustic signal AC1 (first acoustic signal) and the acoustic signal AC3 (third acoustic signal) at the position P2 (second point) with reference to the position P1 (first point) can be set to be larger than or equal to a predetermined value ωₜₕ. Here, the position P1 (first point) is a predetermined point where the emitted acoustic signal AC1 (first acoustic signal) and acoustic signal AC3 (third acoustic signal) reach. On the other hand, the position P2 (second point) is a predetermined point whose distance from the acoustic signal output device 10 is longer than the position P1 (first point). The predetermined value ηₜₕ is a value smaller (value lower) than an attenuation rate η₂₁ of any or specific acoustic signal (sound) due to air propagation at the position P2 (second point) with reference to the position P1 (first point). Furthermore, the predetermined value ωₜₕ is a value larger than an attenuation amount η₂₂ of any or specific acoustic signal (sound) due to air propagation at the position P2 (second point) with reference to the position P1 (first point). That is, the acoustic signal output device 10 of the present embodiment is designed such that the attenuation rate η₁₂ is less than or equal to the predetermined value ηth smaller than the attenuation rate η₂₁, or the attenuation amount η₁₂₂ is larger than or equal to the predetermined value ωₜₕ larger than the attenuation amount η₂₂. Note that the acoustic signal AC1 and the acoustic signal AC3 are propagated in air from the position P1 to the position P2 and are attenuated due to the air propagation, the acoustic signal AC2, and the acoustic signal AC4. The attenuation rate η₁₁₂ is a ratio (AMP₂(AC1)/AMP₁(AC1)) of the magnitude AMP₂(AC1) of the acoustic signal AC1 at the position P2 attenuated due to the air propagation, the acoustic signal AC2, and the acoustic signal AC4 to the magnitude AMP₁(AC1) of the acoustic signal AC1 at the position P1, or a ratio (AMP₂(AC3)/AMP₁(AC13)) of the magnitude AMP₂(AC3) of the acoustic signal AC3 at the position P2 attenuated due to the air propagation, the acoustic signal AC2, and the acoustic signal AC4 to the magnitude AMP₁(AC3) of the acoustic signal AC3 at the position P1. Alternatively, the attenuation rate η₁₁₂ may be a statistical value (an average value, an addition value, a multiplication value, or the like) of the ratio (AMP₂(AC1)/AMP₁(AC1)) and the ratio (AMP₂(AC3)/AMP₁(AC13)). Furthermore, the attenuation amount η₁₂₂ is a difference (|AMP₁(AC1)-AMP₂(AC1)|) between the magnitude AMP₁(AC1) and the magnitude AMP₂(AC1), or a difference (|AMP₁(AC3)-AMP₂(AC3)|) between the magnitude AMP₁(AC3) and the magnitude AMP₂(AC3). Alternatively, the attenuation amount η₁₂₂ may be a statistical value (an average value, an addition value, a multiplication value, or the like) of the difference (|AMP₁(AC1)-AMP₂(AC1)|) and the ratio (|AMP₁(AC3)-AMP₂(AC3)|). On the other hand, in a case where the acoustic signal AC2 and the acoustic signal AC4 are not assumed, any or specific acoustic signal ACₐᵣ propagating in air from the position P1 to the position P2 attenuates not due to the acoustic signal AC2 and the acoustic signal AC4 but due to the air propagation. The attenuation rate η₂₁ is a ratio (AMP₂(ACₐᵣ)/AMP₁(ACₐᵣ)) of a magnitude AMP₂(ACₐᵣ) of the acoustic signal ACₐᵣ at the position P2 attenuated due to air propagation (attenuated not due to the acoustic signal AC2) to a magnitude AMP₁(ACₐᵣ) of the acoustic signal ACₐᵣ at the position P1. Furthermore, the attenuation amount η₂₂ is a difference (|AMP₁(ACₐᵣ)-AMP₂(ACₐᵣ)|) between the magnitude AMP₁(ACₐᵣ) and the magnitude AMP₂(ACₐᵣ).

With the configuration described above, it is possible to reduce the sound leakage. In particular, the size of the driver unit 11 (first driver unit) is smaller than the size of the driver unit 15 (second driver unit). Furthermore, the driver unit 11 is disposed inside the reflector 13, and the acoustic signals AC1 and AC2 emitted from the driver unit 11 are emitted from the open end 130 of the reflector 13 and the sound holes 131b. On the other hand, the driver unit 15 is accommodated inside the housing 16 located outside the reflector 13, and the acoustic signal AC3 emitted from the driver unit 15 is introduced into the inside of the reflector 13 and then emitted further from the open end 130 of the reflector 13. On the other hand, the acoustic signal AC4 emitted from the driver unit 15 is emitted from the sound holes 163a of the housing 16 to the outside of the reflector 13. Therefore, a difference between the propagation distance until the acoustic signal AC1 emitted from the D1 direction side of the diaphragm 113 of the driver unit 11 reaches the position P2 (second point) and the propagation distance until the acoustic signal AC2 (second acoustic signal) emitted from the D2 direction side (the other side) of the diaphragm 113 reaches the position P2 (second point) is smaller than the difference between the propagation distance until the acoustic signal AC3 emitted from the D1 direction side (one side) of the diaphragm 153 of the driver unit 15 reaches the position P2 (second point) and the propagation distance until the acoustic signal AC4 emitted from the D2 direction side (the other side) of the diaphragm 153 reaches the position P2 (second point). Here, the phase difference between the antiphase wave (the acoustic signal AC2 or the acoustic signal AC4) at the position P2 and the reproduced sound (the acoustic signal AC1 or the acoustic signal AC3) is larger as the difference in propagation distance is smaller. Therefore, the sound leakage prevention effect is improved. Therefore, in terms of the size and arrangement, the sound leakage prevention effect is higher on the driver unit 11 side than on the driver unit 15 side. On the other hand, since it is more easily affected by the difference in propagation distance as the frequency is higher. Therefore, the sound leakage prevention effect is more likely to deteriorate as the frequency is higher. Here, the driver unit 11 mainly handles a high-frequency acoustic signal among the reproduced acoustic signals, and the driver unit 15 mainly handles a low-frequency acoustic signal among the reproduced acoustic signals. Therefore, in terms of the frequency, the sound leakage prevention effect is higher on the driver unit 15 side than on the driver unit 11 side. With these characteristics of the sound leakage prevention effect, a sufficient sound leakage prevention effect can be obtained in a wide frequency band. F Furthermore, since the diameter of the diaphragm 153 (second diaphragm) of the driver unit 15 is larger than the diameter of the diaphragm (first diaphragm) of the driver unit 11, the sound pressure of the low sound can be made larger on the driver unit 15 side than the driver unit 11 side. Thus, it is possible to sufficiently obtain a low-frequency sound pressure while suppressing the sound leakage.

<Arrangement Configuration of Sound Holes 161a and 163a>

An arrangement configuration of the sound holes 161a and 163a will be exemplified.

The sound holes 161a (third sound holes) exemplified here are provided in the region AR1 (first region) of the wall portion 161 disposed on one side (D1 direction side that is a side to which the acoustic signal AC3 is emitted) of the driver unit 15 (FIGS. 1 and 4). That is, the sound holes 161a are opened in the D1 direction (first direction) along the axis A1, and are connected to the sound holes 131aa of the reflector 13. Furthermore, the sound holes 163a (fourth sound holes) exemplified here are provided in a region AR3 of the wall portion 163 that is in contact with a region AR between the region AR1 (first region) of the wall portion 161 of the housing 16 and the region AR2 (second region) of the wall portion 162 disposed on the D2 direction side (the other side that is a side to which the acoustic signal AC4 is emitted) of the driver unit 15. That is, assuming that a direction between the D1 direction (first direction) and the opposite direction of the D1 direction is a D12 direction (second direction) using the center of the housing 16 as a reference (FIG. 4), the sound holes 161a (third sound holes) are provided on the D1 direction side (first direction side) of the housing 16, and the sound holes 163a (fourth sound holes) are provided on the D12 direction side (second direction side) of the housing 16. For example, in a case where the housing 16 includes a wall portion 161 disposed on one side (D1 direction side) of the driver unit 15, a wall portion 162 disposed on the other side (D2 direction side) of the driver unit 15, and a wall portion 163 (side surface) surrounding the space sandwiched between the wall portion 161 and the wall portion 162 around the axis A1 along the emission direction (D1 direction) of the acoustic signal AC3 passing through the wall portion 161 and the wall portion 162 (FIG. 4), the sound holes 161a (third sound holes) are provided on the wall portion 161, and the sound holes 163a (fourth sound holes) are provided on the wall portion 163 (side surface). Furthermore, in this example, it is desirable that a sound hole is not provide on the wall portion 162 side of the housing 16. This is because when a sound hole is provided on the wall portion 162 side of the housing 16, the sound pressure level of the acoustic signal AC4 emitted from the housing 16 exceeds a level necessary for cancelling out the sound leakage component of the acoustic signal AC3, and the excess is perceived as sound leakage.

As illustrated in FIG. 1, and the like, the sound holes 161a exemplified here are disposed on or near the axis A1 along the emission direction (D1 direction) of the acoustic signal AC3. The axis A1 of this example passes through the center of the region AR1 (first region) of the wall portion 161 disposed on one side (D1 direction side) of the driver unit 15 of the housing 16 or the vicinity of the center. For example, the axis A1 is an axis extending in the D1 direction through the center region of the housing 16. That is, the sound holes 161a of this example are provided at the center position of the region AR1 of the wall portion 161 of the housing 16. In this example, for simplification of description, an example is described in which the shape of the edge of the open end of each of the sound holes 161a is a circle (the open end is a circle). However, this does not limit the present invention. For example, the shape of the edge of the open end of the sound hole 161a may be another shape such as an ellipse, a quadrangle, and a triangle. Furthermore, the open end of the sound hole 161a may have a mesh shape. In other words, the open end of the sound hole 161a may be formed by a plurality of holes. Furthermore, in this example, for simplification of description, an example is described in which four sound hole 161a are provided in the region AR1 (first region) of the wall portion 161 of the housing 16. However, this does not limit the present invention. For example, one or more sound holes 161a may be provided in the region AR1 (first region) of the wall portion 161 of the housing 16, or other numbers of sound holes 161a may be provided.

The sound holes 163a (fourth sound holes) are desirably disposed in consideration of, for example, the following viewpoints.

(1) Viewpoint of position: The sound holes 163a are disposed such that propagation paths of the acoustic signal AC4 emitted from the sound holes 163a overlap a propagation path of the sound leakage component of the acoustic signal AC3 to be canceled out.

(2) Viewpoint of area: The propagation regions of the acoustic signal AC4 emitted from the sound holes 163a and the frequency characteristics of the housing 16 are different according to the opening areas of the sound holes 163a. Furthermore, the frequency characteristics of the housing 16 affect the frequency characteristics of the acoustic signal AC4 emitted from the sound holes 163a, that is, the amplitude at each frequency. In consideration of such propagation regions and frequency characteristics of the acoustic signal AC4 emitted from the sound holes 163a, the opening areas of the sound holes 163a are determined such that the sound leakage component is canceled out by the acoustic signal AC4 emitted from the sound holes 163a in a region where the sound leakage component is to be canceled out.

From the above viewpoints, for example, the sound holes 163a (fourth sound holes) are desirably formed as follows.

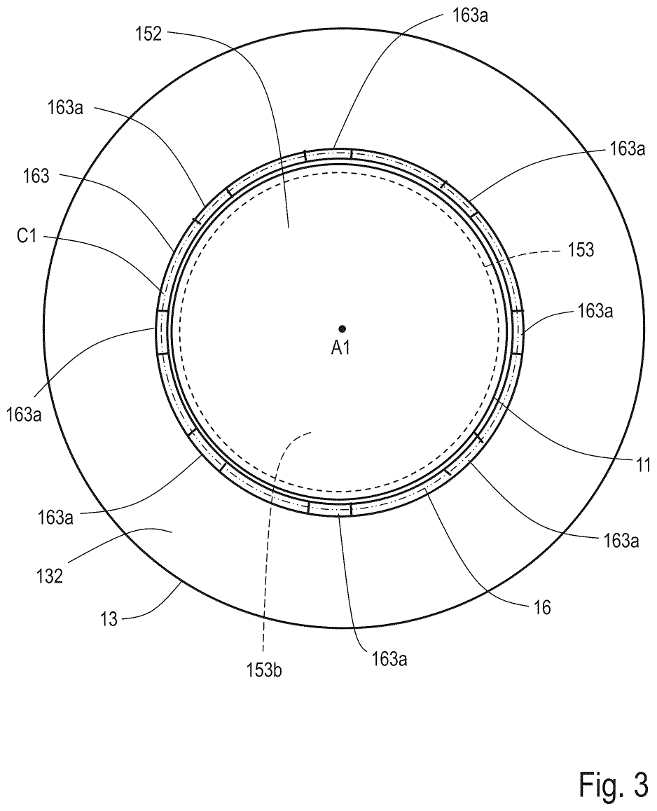

For example, as illustrated in FIGS. 3 and 5, desirably, a plurality of the sound holes 163a (fourth sound holes) are provided along a circumference (circle) C1 centered on the axis A1 along the emission direction of the acoustic signal AC3 (first acoustic signal). In a case where a plurality of the sound holes 163a are provided along the circumference C1, the acoustic signal AC4 is emitted radially (radially around the axis A1) from the sound holes 163a to the outside. Here, the sound leakage component of the acoustic signal AC3 is also emitted radially (radially around the axis A1) from the sound hole 161a to the outside. Therefore, when a plurality of the sound holes 163a are provided along the circumference C1, the sound leakage component of the acoustic signal AC3 can be appropriately canceled out by the acoustic signal AC4. Here, for simplification of description, an example is described in which a plurality of the sound holes 163a are provided on the circumference C1. However, a plurality of sound holes 163a are only required to be provided along the circumference C1, and not all the sound holes 163a need to be strictly disposed on the circumference C1.

Furthermore, preferably, in a case where the circumference C1 is equally divided into a plurality of unit arc regions, the sum of the opening areas of sound holes 163a (fourth sound holes) provided along a first arc region that is one of the unit arc regions is the same as or substantially the same as the sum of the opening areas of sound holes 163a (fourth sound holes) provided along a second arc region that is one of the unit arc regions excluding the first arc region. For example, as illustrated in FIG. 5, in a case where the circumference C1 is equally divided into four unit arc regions C1-1, . . . , and C1-4, the sum of the opening areas of the sound holes 163a (fourth sound holes) provided along the first arc region (for example, unit arc region C1-1) that is one of the unit arc regions C1-1, . . . , and C1-4 is the same as or substantially the same as the sum of the opening areas of the sound holes 163a (fourth sound holes) provided along the second arc region (for example, unit arc region C1-2) that is one of the unit arc regions excluding the first arc region. Note that, for simplification of description, an example has been described in which the circumference C1 is equally divided into four unit arc regions C1-1, . . . , and C1-4, but this does not limit the present invention. Furthermore, “al is substantially the same as α2” means that a difference between α1 and α2 is β % or less of α1. Examples of β % include 3%, 5%, and 10%. Thus, the sound pressure distribution of the acoustic signal AC4 emitted from the sound holes 163a provided along the first arc region and the sound pressure distribution of the acoustic signal AC4 emitted from the sound holes 163a provided along the second arc region are axially symmetric or substantially axially symmetric to the axis A1. Preferably, the sums of the opening areas of sound holes 163a (fourth sound holes) provided along the unit arc regions for the respective unit arc regions are all the same or substantially the same. Thus, the sound pressure distribution of the acoustic signal AC4 emitted from the sound holes 163a is axially symmetric or substantially axially symmetric to the axis A1. Thus, the sound leakage component of the acoustic signal AC3 can be more appropriately canceled out by the acoustic signal AC4.

More preferably, a plurality of the sound holes 163a having the same shape, the same size, and the same interval is desirably provided along the circumference C1. In a case where a plurality of the sound holes 163a having the same shape, the same size, and the same interval is provided along the circumference C1, the sound leakage component of the acoustic signal AC3 can be more appropriately canceled out by the acoustic signal AC4. However, the present invention is not limited thereto.

Here, for simplicity of description, a case where the shape of the edge of the open end of each of the sound holes 163a is a quadrangle (case where the open ends are rectangles) is exemplified, but this does not limit the present invention. For example, the shape of the edge of the open end of the sound hole 163a may be another shape such as a circle, an ellipse, and a triangle. Furthermore, the open end of the sound hole 163a may have a mesh shape. In other words, the open end of the sound hole 163a may be formed by a plurality of holes. Furthermore, the number of sound holes 163a is not limited, and a single sound hole 163a may be provided in the region AR3 of the wall portion 163 of the housing 16, or a plurality of the sound holes 163a may be provided.

<Cutoff Frequency of Reflector 13 in which Driver Unit 11 is Disposed>

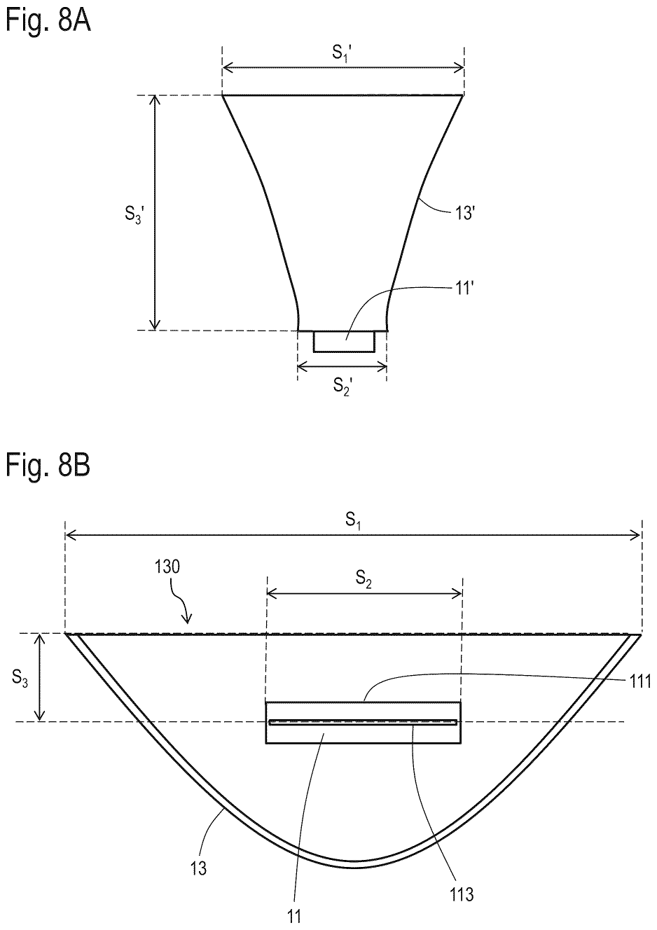

The cutoff frequency of the reflector 13 in which the driver unit 11 is disposed will be considered. FIG. 8A illustrates a horn speaker in which a horn 13′ is attached to a driver unit 11′. Here, the opening area of a mouth portion of the horn 13′ is set to S₁′, the opening area of a throat portion of the horn 13′ is set to S₂′, and the length of the horn 13′ is S₃′. The driver unit 11′ is attached to the mouth portion of the horn 13′. The cutoff frequency f_{c} of the horn speaker is represented by Equation (1) below.

$$\begin{matrix}[ Math . 1 ] & \\ {f}_{c} = \frac{m c}{4 π} & ( 1 )\end{matrix}$$

Here, m represents a spreading coefficient, and c represents a sound speed. Note that the sound pressure of the acoustic signal emitted from the mouth portion of the horn speaker rapidly decreases when the sound pressure exceeds the cutoff frequency f_{c}. That is, the cutoff frequency f_{c} represents the frequency characteristics of the acoustic signal that can be output from the horn speaker. Here, it is known that the relationship of Equation (2) below.

$$\begin{matrix}[ Math . 2 ] & \\ {S}_{2}^{′} = {S}_{1}^{′} {e}^{m {S}_{3} ′} & ( 2 )\end{matrix}$$

When Equation (2) is modified, Equation (3) is satisfied below.

$$\begin{matrix}[ Math . 3 ] & \\ {mS}_{3}^{′} = {log}_{e} \frac{{S}_{2}^{′}}{{S}_{1}^{′}} & ( 3 )\end{matrix}$$

Moreover, when Equation (3) is modified, the spreading coefficient m can be approximated as in Equation (4) below.

$$\begin{matrix}[ Math . 4 ] & \\ m \approx \frac{2.3}{{S}_{3}^{′}} {log}_{10} \frac{{S}_{2}^{′}}{{S}_{1}^{′}} & ( 4 )\end{matrix}$$

Although the reflector 13 of the present embodiment is different from the horn, it is considered that the cutoff frequency of the reflector 13 in which the driver unit 11 is disposed exhibits characteristics close thereto. FIG. 8B illustrates the reflector 13 in which the driver unit 11 of the present embodiment is disposed. Here, the opening area S₁ of the open end 130 of the reflector 13 is regarded as the opening area S′ of the mouth portion of the horn, the area S₂ of the surface 111 of the driver unit 11 is regarded as the opening area S₂′ of the throat portion of the horn, and the length S₃ from the surface 111 of the driver unit 11 to the open end 130 of the reflector 13 is regarded as the length S₃′ of the horn. Then, from Equations (1) and (4), the cutoff frequency f_{c} of the reflector 13 in which the driver unit 11 is disposed can be approximated as in Equation (5) below.

$$\begin{matrix}[ Math . 5 ] & \\ {f}_{c} \approx \frac{2.3 c}{4 π {S}_{3}} {log}_{10} \frac{{S}_{2}}{{S}_{1}} & ( 5 )\end{matrix}$$

That is, the reflector 13 in which the driver unit 11 is disposed can be regarded as a speaker having the cutoff frequency f_{c} represented by Equation (5).

### <Reproduction Device 100 and Signal Separation Device 101>

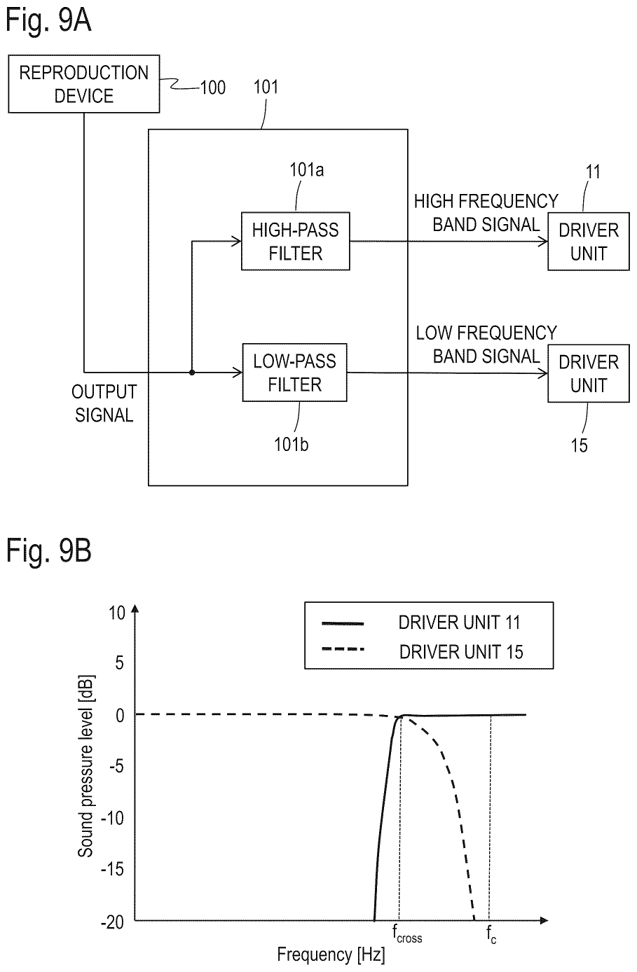

As illustrated in FIG. 9A, the output signal output from a reproduction device 100 is input to a signal separation device 101. The signal separation device 101 separates the input output signal into a high frequency band signal on the high-frequency side and a low frequency band signal on the low-frequency side. In the example of FIG. 9B, the output signal is branched into two, and the branched output signals are input to a high-pass filter 101a and a low-pass filter 101b, respectively. The high-pass filter 101a attenuates the low-frequency side of the input output signal to obtain and output a high frequency band signal. The low-pass filter 101b attenuates the high-frequency side of the input output signal to obtain and output a low frequency band signal. The high frequency band signal is input to the driver unit 11 of the acoustic signal output device 10, and the driver unit 11 emits the acoustic signal AC1 to the D1 direction side and emits the acoustic signal AC2 to the D2 direction side. The low frequency band signal is input to the driver unit 15 of the acoustic signal output device 10, and the driver unit 15 emits the acoustic signal AC3 to the D1 direction side and emits the acoustic signal AC4 to the D2 direction side.

As illustrated in FIG. 9B, in the present embodiment, the cross frequency is set to f_{cross}, the driver unit 11 emits the acoustic signals AC1 and AC2 in the high frequency band having sufficient sound pressure at a frequency higher than or equal to the cross frequency f_{cross}, and the driver unit 15 emits the acoustic signals AC3 and AC4 in the low frequency band having a sufficient sound pressure at a frequency lower than or equal to the cross frequency f_{cross}. That is, the low-pass filter 101b outputs a signal in the low frequency band having sufficient sound pressure at a frequency lower than or equal to the cross frequency f_{cross}. Furthermore, the high-pass filter 101a outputs a signal in the high frequency band having a sufficient sound pressure at a frequency higher than or equal to the cross frequency f_{cross}. At this time, the cross frequency f_{cross} is desirably set to be lower than the cutoff frequency f_{c} of the speaker constituted by the driver unit 11 and the reflector 13 represented by Equation (5). That is, the cross frequency f_{cross} between the high frequency band and the low frequency band is desirably lower than the cutoff frequency f_{c} represented by Equation (5). For example, an example of the cross frequency f_{cross} is 1000 [Hz] or the vicinity thereof, and the cutoff frequency f_{c} is a frequency higher than 1000 [Hz]. Thus, the sufficient sound pressure is obtained in the high frequency band. Note that the cross frequency f_{cross} and the cutoff frequency f_{c} are only required to be determined so as to obtain all-band signals having a desired frequency characteristics at the user's listening point located on the D1 direction side.

### Experiment Results

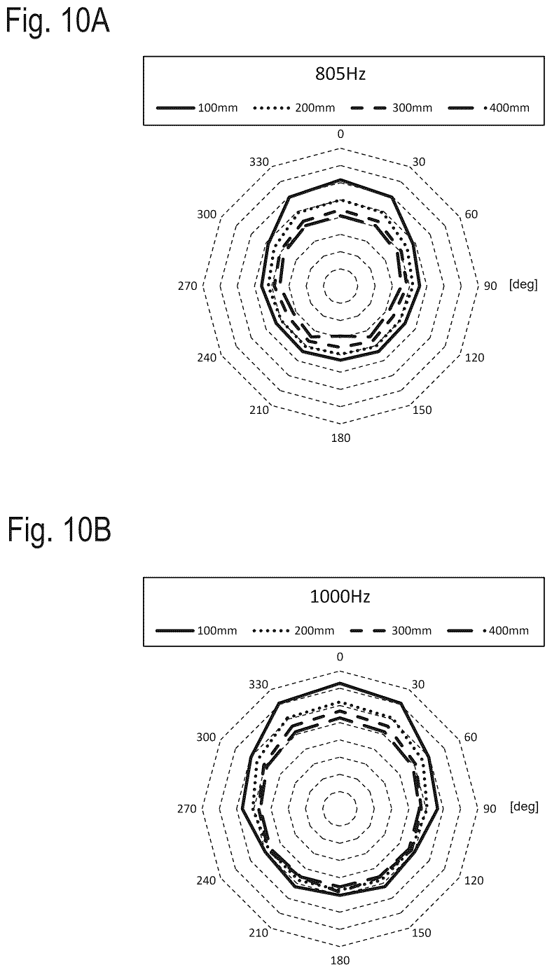

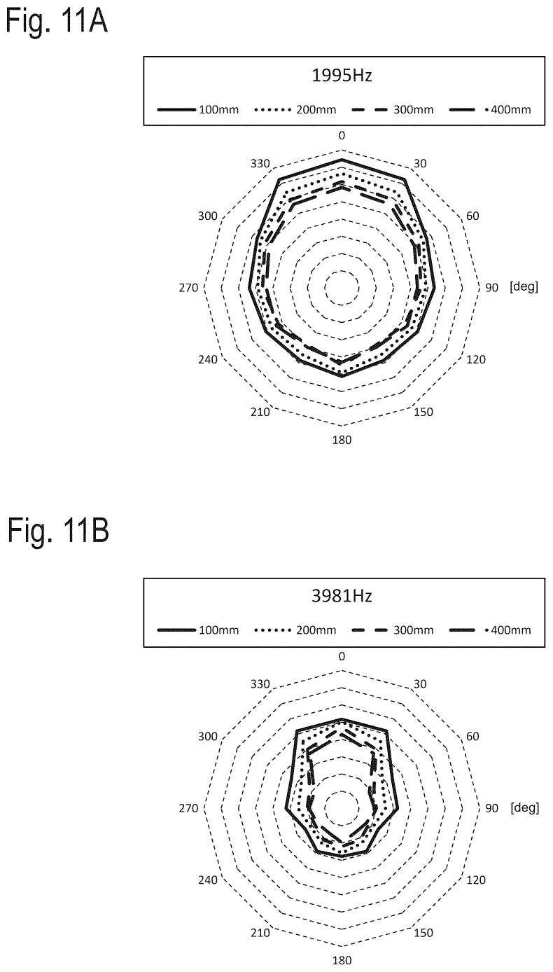

Experimental results will be provided below. FIGS. 10A, 10B, 11A, 11B, and 12 illustrate graphs (radar charts) representing sound pressures at frequencies of 805 Hz, 1000 Hz, 1995 Hz, 3981 Hz, and 7943 Hz of the acoustic signals measured around the acoustic signal output device 10 of the present embodiment, respectively. 0 [deg] represents the D1 direction, 180 [deg] represents the D2 direction, and lines represent sound pressure levels at positions 100 mm, 200 mm, 300 mm, and 400 mm away from the acoustic signal output device 10 in the respective directions. In these graphs, the closer to the center, the lower the sound pressure level, and the closer to the outside, the higher the sound pressure level.

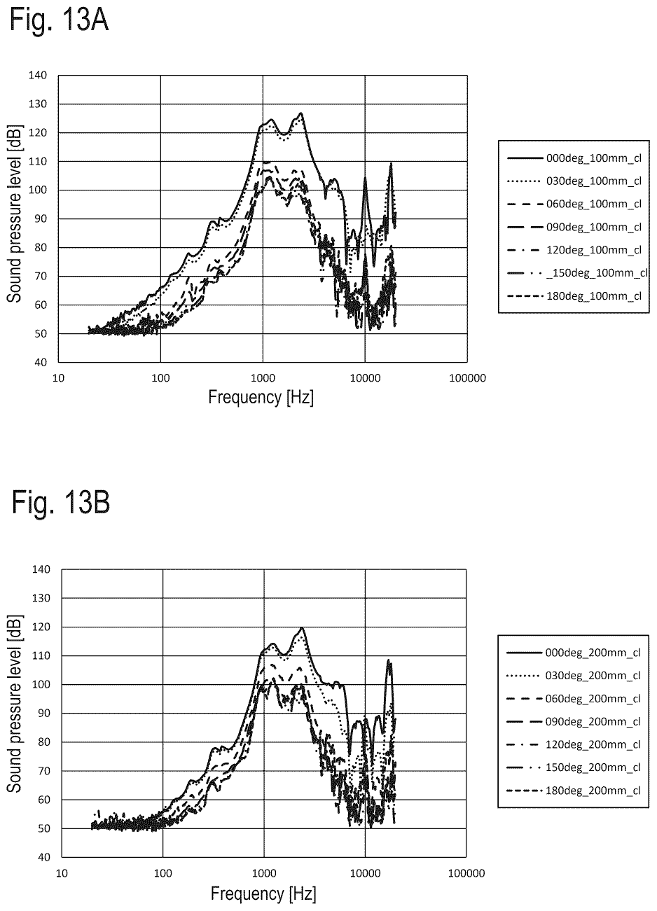

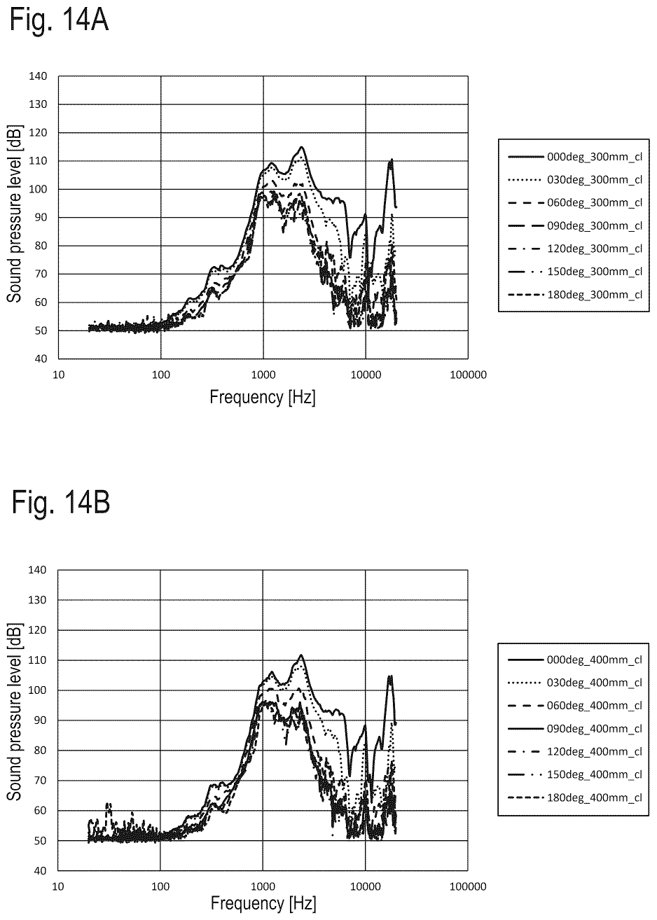

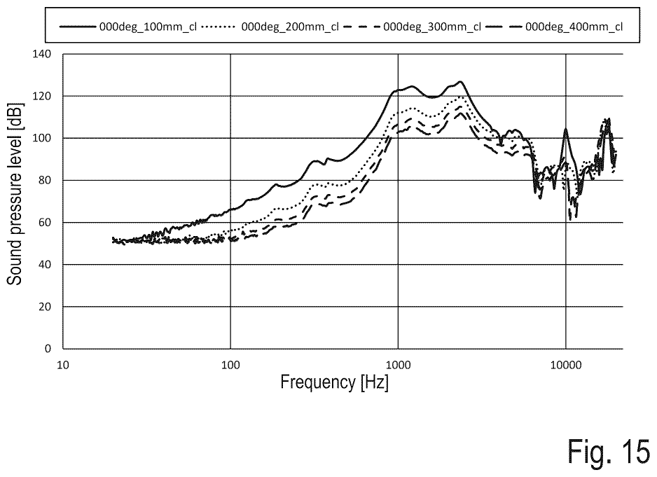

FIGS. 13A to 15 illustrate graphs representing frequency characteristics of an acoustic signal measured around the acoustic signal output device 10 of the present embodiment. The horizontal axis of these graphs represents the frequency [Hz], and the vertical axis represents the sound pressure level [dB]. Each line represents a sound pressure level [dB] in each direction [deg] and at each relative position [mm] with respect to the acoustic signal output device 10. “aaa deg_bbb_mm_cl” in the legends of these graphs represents the sound pressure level [dB] measured at the position where the direction with respect to the acoustic signal output device 10 is aaa [deg] and the relative position is bbb [mm].

As described above, in the acoustic signal output device 10 of the present embodiment, it is possible to sufficiently suppress sound leakage to other positions while securing a sufficient sound pressure in a specific region on the D1 direction side in a wide frequency band. In particular, due to the directivity of the reflector 13, the sound leakage to other positions can be sufficiently suppressed while securing the sufficient sound pressure in a specific region on the D1 direction side even at a high frequency exceeding 1000 Hz. As described above, in the present embodiment, sound leakage to the surroundings can be suppressed in a wide frequency band including the high frequency.

### First Modification Example of First Embodiment

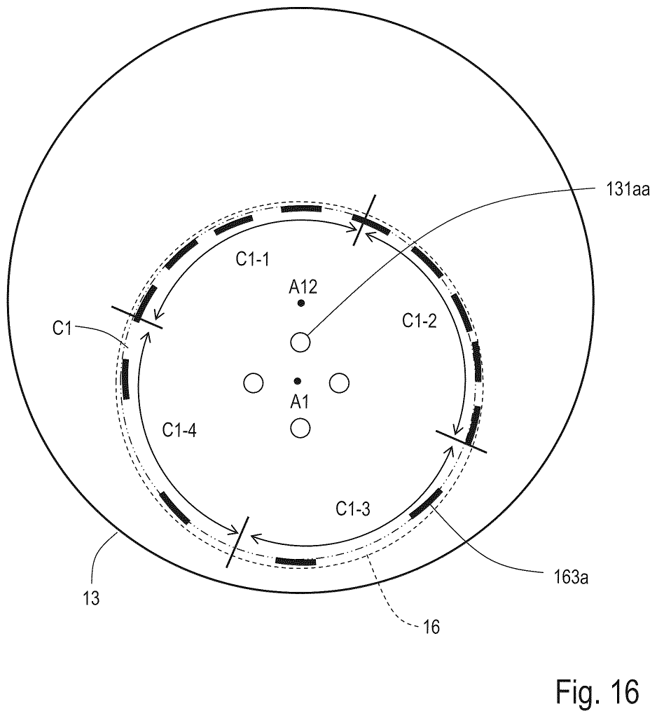

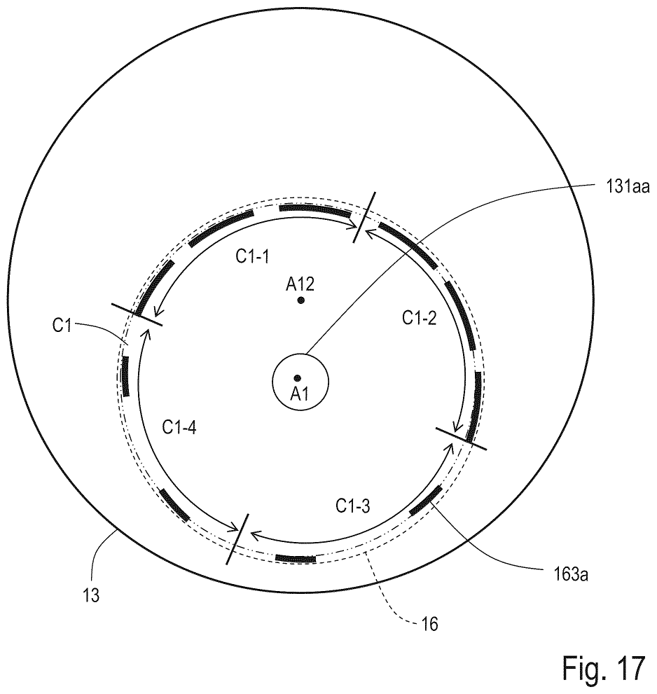

Hereinafter, description will focus on differences from the matters described so far, and description of portions that have already been described will be simplified. As described above, the single sound hole 161a may be provided in the region AR1 of the wall portion 161 of the housing 16, or a plurality of the sound holes 161a may be provided, or the single sound hole 131aa connected to the sound hole 161a may be provided on the bottom portion 131a side of the reflector 13, or a plurality of the sound holes 131aa may be provided. Furthermore, the reflector 13 may be deviated to an eccentric position (a position on an axis A12 parallel to the axis A1 and deviated from axis A1) deviated from the center (center position) of the housing 16 (hereinafter, simply referred to as an “eccentric position”). For example, as illustrated in FIG. 16, the center for a plurality of the sound holes 161a and 131aa may be disposed on the axis A1, and the reflector 13 may be biased on the axis A12. Alternatively, as illustrated in FIG. 17, one sound hole 161a and one sound hole 131aa may be disposed on the axis A1, and the reflector 13 may be biased on the axis A12. In other words, the reflector 13 may be disposed to be biased with respect to the housing 16, one sound hole 161a, and one sound hole 131aa.

In a case where the reflector 13 is disposed to be biased with respect to the housing 16, one sound hole 161a and one sound hole 131aa, the distribution and opening area of the sound hole 163a may be biased accordingly to this. In the example of FIG. 16, the number of sound holes 163a provided along the unit arc regions C1-3 and C1-4 distant from the axis A12 is smaller than the number of sound holes 163a provided along the unit arc regions C1-1 and C1-2 closer to the axis A12. In the example of FIG. 17, the opening area of each of the sound holes 163a provided along the unit arc regions C1-3 and C1-4 distant from the axis A12 is smaller than the opening area of each of the sound holes 163a provided along the unit arc regions C1-1 and C1-2 closer to the axis A12. That is, in a case where the circumference C1 is equally divided into a plurality of unit arc regions, the sum of the opening areas of the sound holes 163a (second sound holes) provided along the first arc region (for example, C1-3 or C1-4) that is one of the unit arc regions is smaller than the sum of the opening areas of the sound holes 163a provided along the second arc region (for example, C1-1 or C1-2) that is one of the unit arc regions closer to the axis A12 than the first arc region. In a case where the reflector 13 is biased to an eccentric position and disposed, the distribution of the acoustic signal AC3 emitted from the open end 130 of the reflector 13 to the outside is also biased to the eccentric position. Here, the distribution and the opening areas of the sound holes 163a are also made biased to the eccentric position, and thus the distribution of the acoustic signal AC4 emitted from the sound holes 163a to the outside can also be biased to the eccentric position. Thus, the sound leakage component of the acoustic signal AC3 can be more sufficiently canceled out by the emitted acoustic signal AC4.

### Second Modification Example of First Embodiment

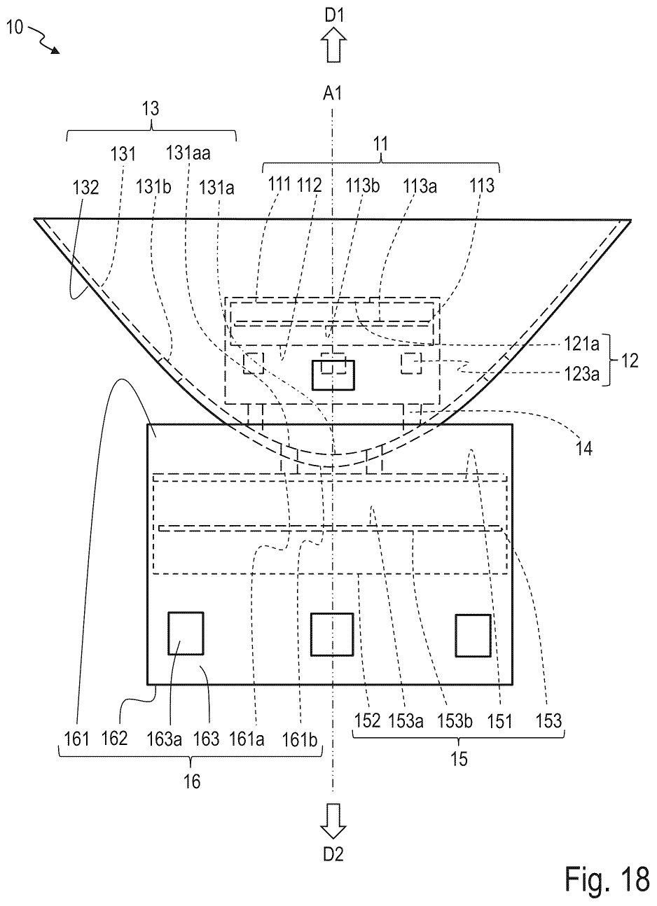

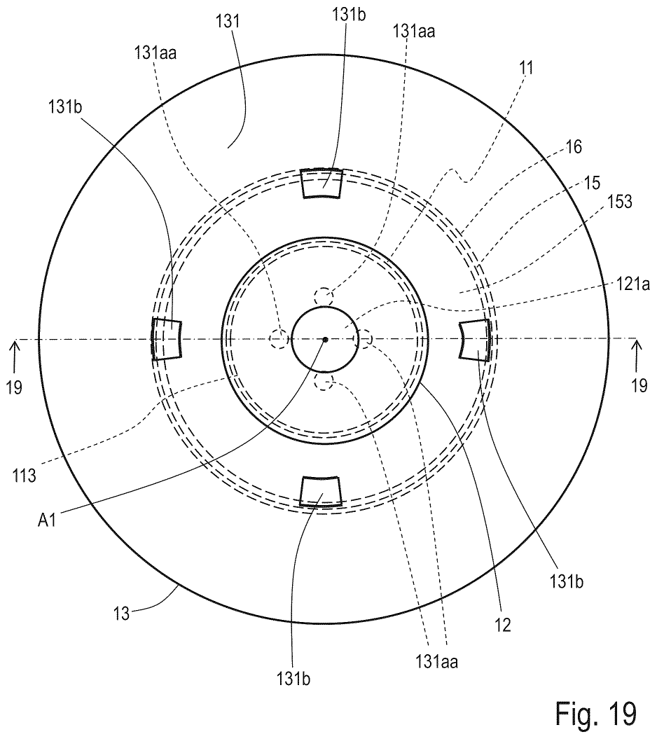

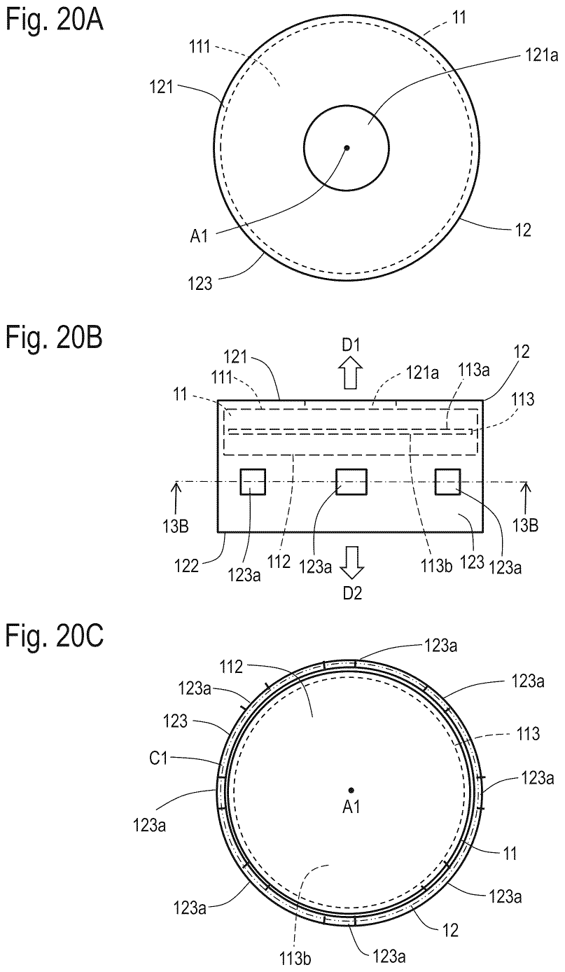

As illustrated in FIGS. 18 to 21, in the first embodiment or the first modification example thereof, the driver unit 11 (first driver unit) may be accommodated in a housing 12 (first housing) different from the housing 16 (second housing), and the housing 12 accommodating the driver unit 11 may be disposed inside the reflector 13 in this manner.

### <Housing 12>

The housing 12 is a hollow member having a wall portion on the outer side, sound holes 121a and 123a are provided on the wall portion, and the driver unit 11 is accommodated in the housing 12. For example, the driver unit 11 is fixed to an end portion on the D1 direction side inside the housing 12. Although the shape of the housing 12 is not limited, for example, the shape of the housing 12 is desirably rotationally symmetric (axially symmetric) or substantially rotationally symmetric to the axis A1. Thus, it is easy to provide the sound holes 123a so as to reduce variation in each direction of the energy of the acoustic signal emitted from the housing 12. For example, the housing 12 includes a first end surface that is a wall portion 121 disposed on one side (D1 direction side) of the driver unit 11, a second end surface that is a wall portion 122 disposed on the other side (D2 direction side) of the driver unit 11, and a side surface that is a wall portion 123 surrounding a space sandwiched between the first end surface and the second end surface around the axis A1 passing through the first end surface and the second end surface. Here, for simplification of description, an example is described in which the housing 12 has a substantially cylindrical shape including opposite end surfaces. However, these are examples and do not limit the present invention. For example, the housing 12 may have a substantially dome shape including a wall portion at an end portion, or may have a hollow substantially cubic shape, or may have another three-dimensional shape. Furthermore, the material of the housing 12 is not limited. The housing 12 may be formed of a rigid body such as synthetic resin or metal or may be formed of an elastic body such as rubber.

<Sound Holes 121a and 123a>

As described above, the wall portion of the housing 12 includes a sound hole 121a (first sound hole) for leading out the acoustic signal AC1 (first acoustic signal) emitted from the driver unit 11 to the outside (inside of the reflector 13) and sound holes 123a (second sound holes) for leading out the acoustic signal AC2 (second acoustic signal) emitted from the driver unit 11 to the outside (inside the reflector 13). The sound hole 121a and the sound holes 123a are, for example, through holes penetrating the wall portion of the housing 12, but this does not limit the present invention. As long as the acoustic signal AC1 and the acoustic signal AC2 can be led out to the outside (inside the reflector 13), the sound hole 121a and the sound holes 123a may not be through holes.

An arrangement configuration of the sound holes 121a and 123a will be exemplified.

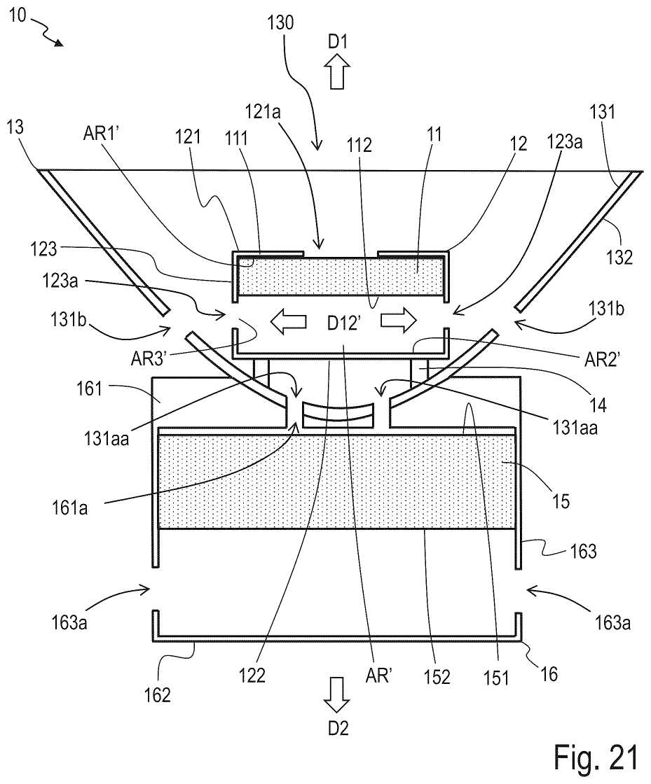

The sound hole 121a (first sound hole) exemplified here is provided in the region AR1 (first region) of the wall portion 121 disposed on one side (D1 direction side that is a side to which the acoustic signal AC1 is emitted) of the driver unit 11 (FIGS. 18, 19, 20A, 20B, and 21). That is, the sound hole 121a is opened in the D1 direction (first direction) along the axis A1. Furthermore, the sound holes 123a (second sound holes) exemplified here are provided in a region AR3′ of the wall portion 123 that is in contact with a region AR′ between a region AR1′ of the wall portion 121 of the housing 12 and a region AR2′ of the wall portion 122 disposed on the D2 direction side (the other side that is the side to which the acoustic signal AC2 is emitted) of the driver unit 11. That is, assuming that a direction between the D1 direction (first direction) and the opposite direction of the D1 direction is a D12′ direction (second direction) using the center of the housing 12 as a reference (FIG. 21), the sound hole 121a (first sound hole) is provided on the D1 direction side (first direction side) of the housing 12, and the sound holes 123a (second sound holes) are provided on the D12′ direction side (second direction side) of the housing 12. For example, in a case where the housing 12 includes a wall portion 121 disposed on one side (D1 direction side) of the driver unit 11, a wall portion 122 disposed on the other side (D2 direction side) of the driver unit 11, and a wall portion 123 (side surface) surrounding the space sandwiched between the wall portion 121 and the wall portion 122 around the axis A1 along the emission direction (D1 direction) of the acoustic signal AC1 passing through the wall portion 121 and the wall portion 122 (FIG. 18), the sound hole 121a (first sound hole) is provided on the wall portion 121, and the sound holes 123a (second sound holes) are provided on the wall portion 123 (side surface).

As illustrated in FIG. 18, and the like, the sound hole 121a exemplified here is disposed on or near the axis A1 along the emission direction (D1 direction) of the acoustic signal AC1. That is, the sound hole 121a of this example is provided at the center position of the region AR1 of the wall portion 121 of the housing 12. In this example, for simplification of description, an example is described in which the shape of the edge of the open end of the sound hole 121a is a circle (the open end is a circle). However, this does not limit the present invention. For example, the shape of the edge of the open end of the sound hole 121a may be another shape such as an ellipse, a quadrangle, and a triangle. Furthermore, the open end of the sound hole 121a may have a mesh shape. In other words, the open end of the sound hole 121a may be formed by a plurality of holes. Furthermore, in this example, for simplification of description, an example is described in which one sound hole 121a is provided in the region AR1 (first region) of the wall portion 121 of the housing 12. However, this does not limit the present invention. For example, two or more sound holes 121a may be provided in the region AR1 (first region) of the wall portion 121 of the housing 12.

A plurality of the sound holes 123a (second sound holes) are desirably provided along a circumference (circle) C1 centered on the axis A1 along the emission direction of the acoustic signal AC1 (first acoustic signal). Here, for simplification of description, an example is described in which a plurality of the sound holes 123a are provided on the circumference C1. However, a plurality of the sound holes 123a are only required to be provided along the circumference C1, and not all the sound holes 123a need to be strictly disposed on the circumference C1.

Furthermore, preferably, in a case where the circumference C1 is equally divided into a plurality of unit arc regions, the sum of the opening areas of sound holes 123a (second sound holes) provided along the first arc region that is one of the unit arc regions is the same as or substantially the same as the sum of the opening areas of sound holes 123a (second sound holes) provided along the second arc region that is one of the unit arc regions excluding the first arc region.

More preferably, a plurality of the sound holes 123a having the same shape, the same size, and the same interval are desirably provided along the circumference C1. In a case where a plurality of the sound holes 123a having the same shape, the same size, and the same interval are provided along the circumference C1, the sound leakage component of the acoustic signal AC1 can be more appropriately canceled out by the acoustic signal AC2. However, the present invention is not limited thereto.

Here, for simplicity of description, a case where the shape of the edge of the open end of each of the sound holes 123a is a quadrangle (case where the open end is a rectangle) is exemplified, but this does not limit the present invention. For example, the shape of the edge of the open end of the sound holes 123a may be another shape such as a circle, an ellipse, and a triangle. Furthermore, the open end of the sound hole 123a may have a mesh shape. In other words, the open end of the sound hole 123a may be formed by a plurality of holes. Furthermore, the number of sound holes 123a is not limited, and a single sound hole 123a may be provided in the region AR3 of the wall portion 123 of the housing 12, or a plurality of the sound holes 123a may be provided.

The housing 12 is fixed to the inner wall surface 131 of the reflector 13 via the support portion 14. In the present embodiment, the sound hole 121a side of the housing 12 disposed inside the reflector 13 is directed to the open end 130 side (D1 direction side) of the reflector 13, and the wall portion 122 on the other side is directed to the bottom portion 131a side (D2 direction side) of the reflector 13. Preferably, at least a part of the sound holes 123a of the housing 12 are provided at positions facing the sound holes 131b of the reflector 13.

### Third Modification Example of First Embodiment

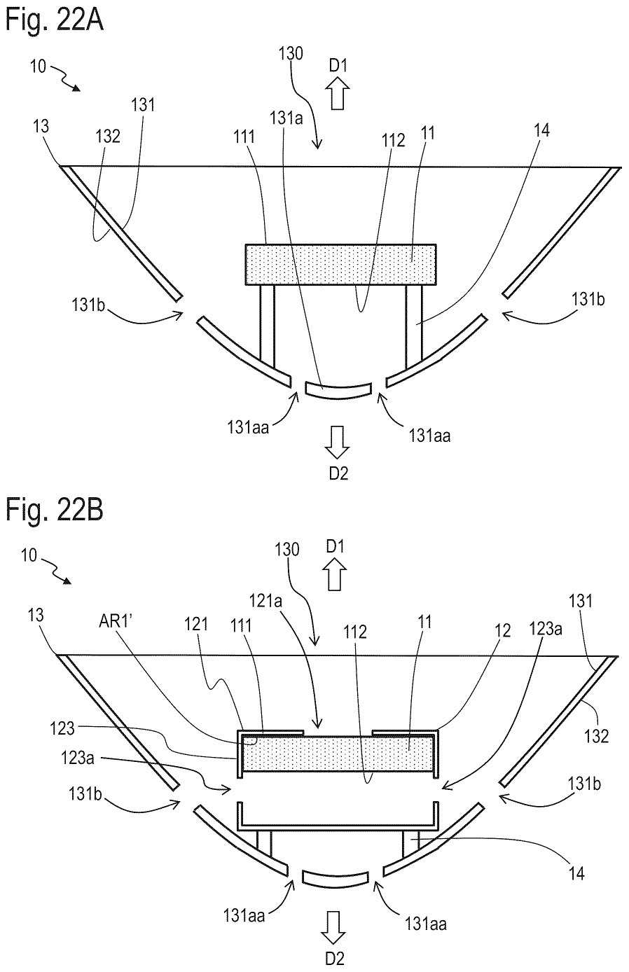

As illustrated in FIGS. 22A and 22B, in the first embodiment and the first and second modification examples thereof, the housing 16 and the driver unit 15 (second driver unit) may be omitted. In this case, the sound holes 131aa may be omitted.

### Second Embodiment

In the first embodiment and the modifications thereof, instead of the sound holes 131b or in addition to the sound holes 131b, a cutout portion (slit portion) 231b that opens the inside of the reflector 13 to the outside may be provided on a part of the open end 130 side of the reflector 13. As described above, the acoustic signal AC1 and the acoustic signal AC2 are emitted from the open end 130 of the reflector 13. Here, the acoustic signal AC2 is an antiphase signal of the acoustic signal AC1 or an approximate signal of the antiphase signal. Therefore, at a specific position P22 on the D1 direction side other than a position P21 where the user is present, a part of the acoustic signal AC1 cancels out a part of the acoustic signal AC2, and thus the sound leakage of the acoustic signal AC1 at the position P22 is suppressed. However, in the high-frequency components of the acoustic signals AC1 and AC2, the high-frequency components are difficult to cancel out each other, and conversely, at the position P22, the acoustic signal AC2 may enhance the acoustic signal AC1 and promote the sound leakage. On the other hand, by providing a cutout portion 231b on a part of the open end 130 side of the reflector 13, the sound leakage at the position P22 can be suppressed. The sound pressure level of the acoustic signal AC2 at the position P22 can be lowered by increasing the size of the cutout portion 231b. Therefore, the size of the cutout portion 231b is only required to be designed such that the sound pressure of the acoustic signal AC2 (second acoustic signal) at the specific position P22 in the direction of the open end 130 of the reflector 13 becomes less than or equal to a predetermined level. For example, the size of the cutout portion 231b is only required to be designed such that the sound pressure of the acoustic signal AC2 (second acoustic signal) at a predetermined frequency or more at the position P22 becomes less than or equal to a predetermined level. The cutout portion 231b will be exemplified below.

### <First Example of Cutout Portion 231b (Cutout Portion 231b-SW)>

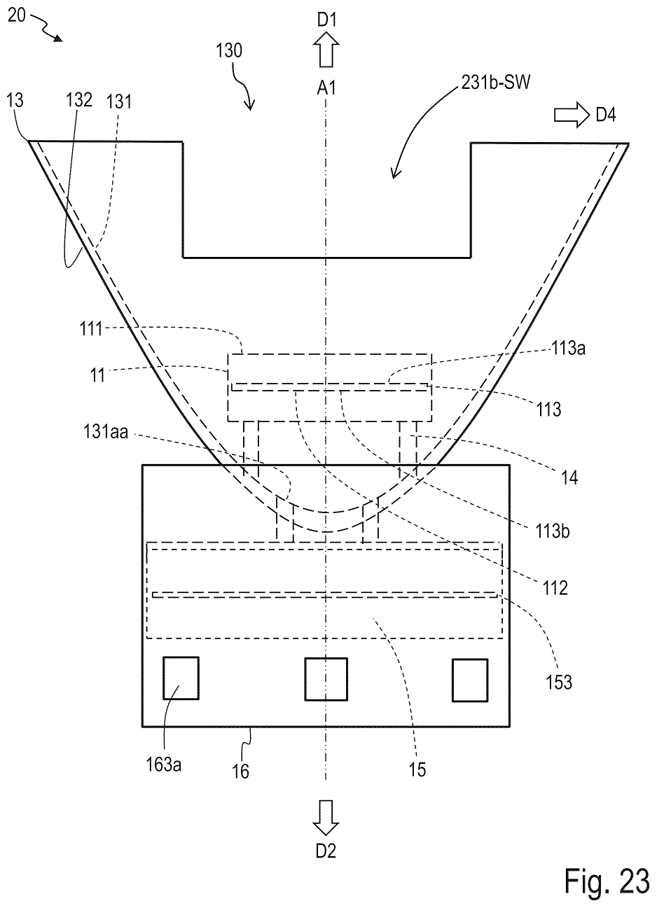

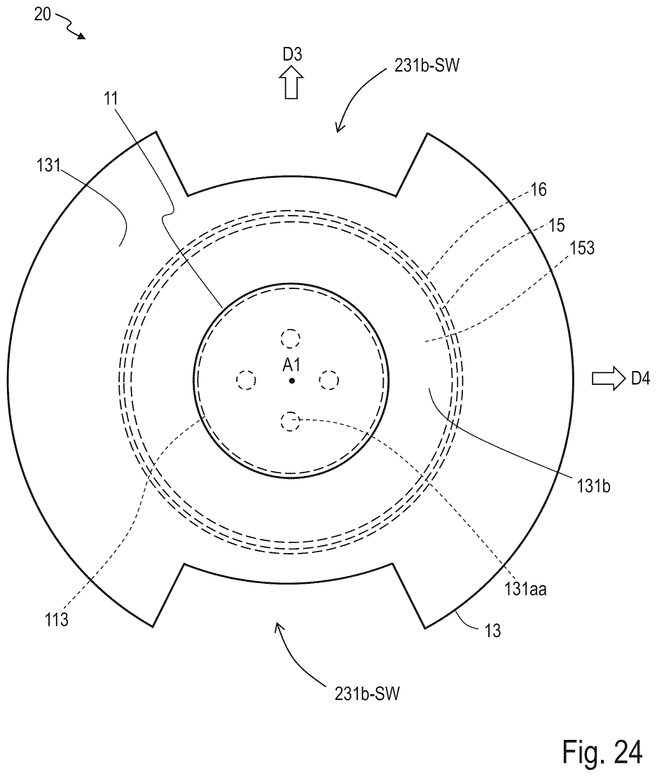

In an acoustic signal output device 20 illustrated in FIGS. 23 and 24, instead of the sound holes 131b, a horizontally long cutout portion 231b-SW that opens the inside of the reflector 13 to the outside is provided on a part of the open end 130 side of the reflector 13. That is, the shape of the cutout portion 231b-SW in this example is long in a D4 direction orthogonal to a D1-D2 direction rather than in the D1-D2 direction.

<Second Example of Cutout Portion 231b (Cutout Portion 231b-LW)>

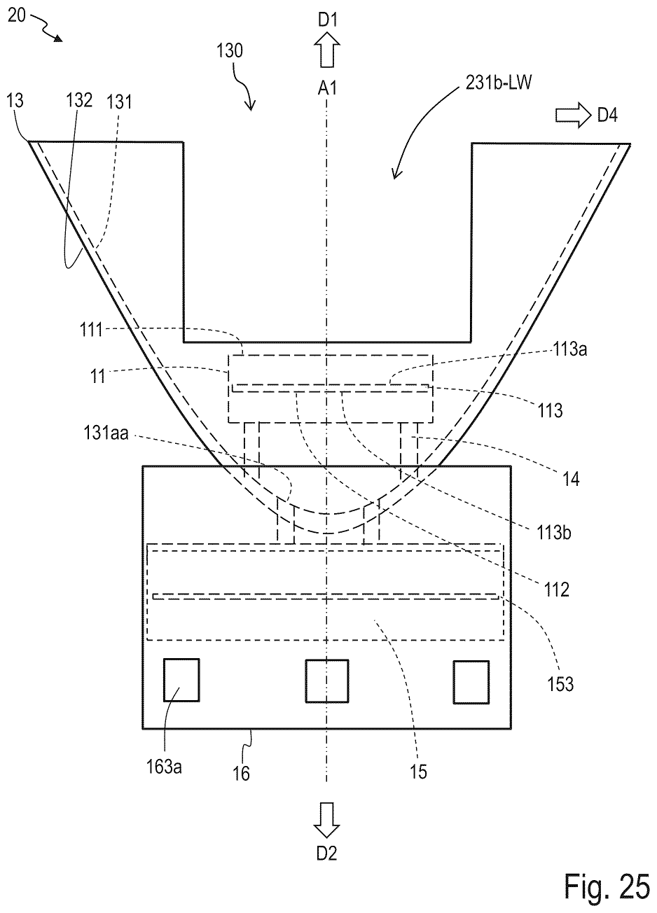

In the acoustic signal output device 20 illustrated in FIG. 25, instead of the sound holes 131b, a vertically and horizontally large cutout portion 231b-LW that opens the inside of the reflector 13 to the outside is provided on a part of the open end 130 side of the reflector 13. That is, the length of the cutout portion 231b-LW in the D1-D2 direction in this example is the same as the length of the cutout portion 231b-SW in the D1-D2 direction in FIG. 23, but the length of the cutout portion 231b-LW in the D4 direction is longer than the length of the cutout portion 231b-SW in the D4 direction.

### <Third Example of Cutout Portion 231b (Cutout Portion 231b-LN)>

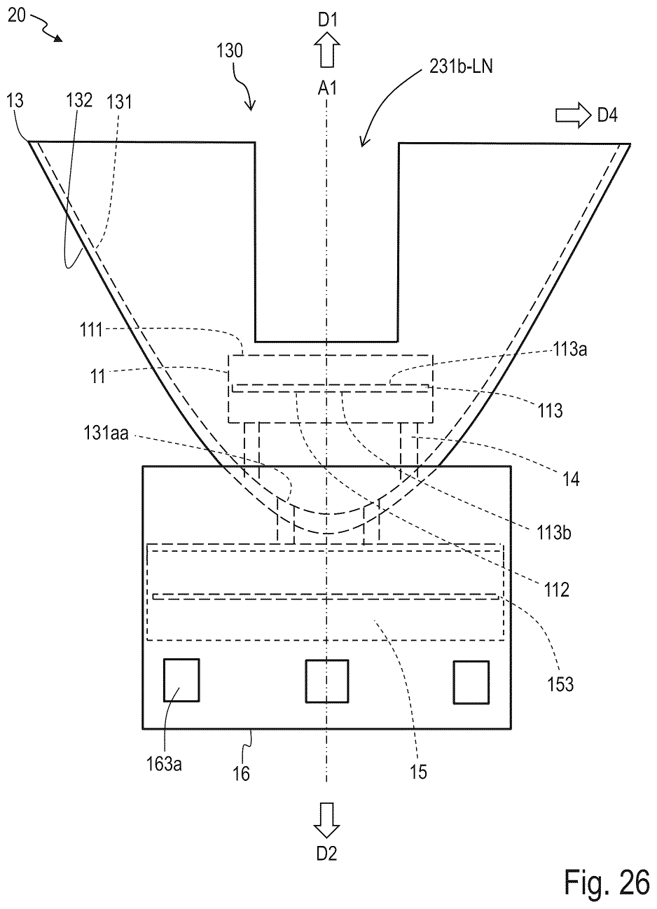

In the acoustic signal output device 20 illustrated in FIG. 26, instead of the sound holes 131b, a vertically long cutout portion 231b-LN that opens the inside of the reflector 13 to the outside is provided on a part of the open end 130 side of the reflector 13. That is, the length of the cutout portion 231b-LN in the D1-D2 direction in this example is the same as the length of the cutout portion 231b-LW in the D1-D2 direction in FIG. 25, but the length of the cutout portion 231b-LN in the D4 direction is longer than the length of the cutout portion 231b-LW in the D4 direction.

### Experiment Results

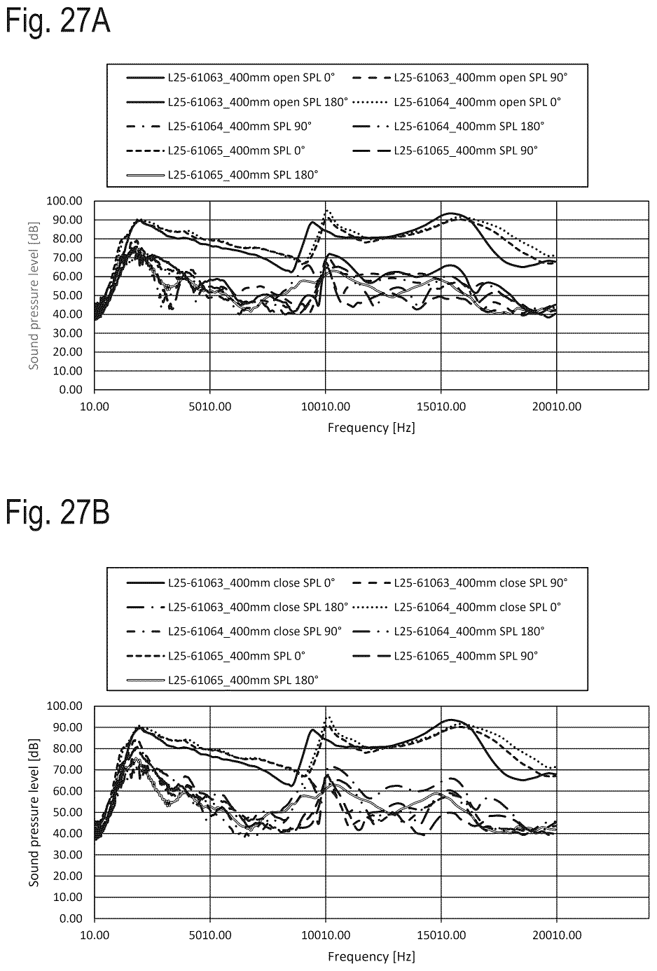

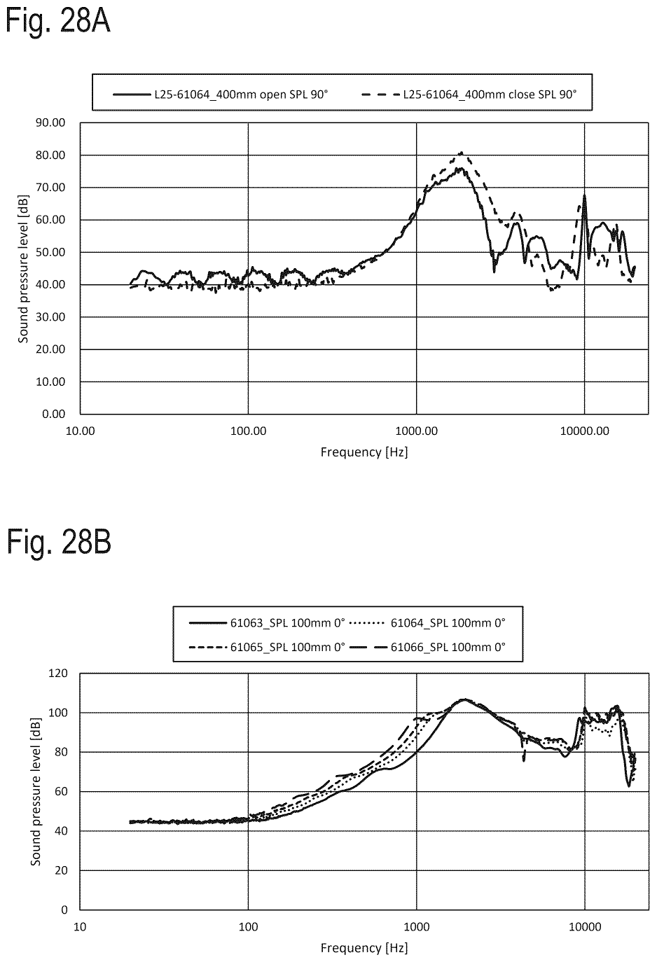

FIGS. 27 and 28 show the experiment results. The vertical axis represents a sound pressure level [dB], and the horizontal axis represents a frequency [Hz]. “L25-aaaaa_bbb mm. open SPL c°” in the legend represents the sound pressure measured outside (FIG. 24) on the D3 direction side (cutout portion 231b side) of the acoustic signal output device 20. On the other hand, “L25-aaaaa_bbb mm. close SPL c°” represents the sound pressure measured outside on the D4 direction side of the acoustic signal output device 20 (the side on which the cutout portion 231b is not provided). A line with “L25-aaaaa” being “L25-61065” represents a measurement result of the acoustic signal output device 20 provided with the cutout portion 231b-SW (FIG. 24). A line with “L25-aaaaa” being “L25-61063” represents a measurement result of the acoustic signal output device 20 provided with the cutout portion 231b-LW (FIG. 25). A line with “L25-aaaaa” being “L25-61064” represents a measurement result of the acoustic signal output device 20 provided with the cutout portion 231b-LN (FIG. 26). “bbb mm” represents a distance from the acoustic signal output device 20 to the measurement position. “c°” represents the direction of the measurement position with respect to the acoustic signal output device 20. “c°” being 0° represents that the direction of the measurement position with respect to the acoustic signal output device 20 is the D1 direction. “c°” being 90° represents that the direction of the measurement position with respect to the acoustic signal output device 20 is a direction orthogonal to the D1-D2 direction. “c°” being 180° represents that the direction of the measurement position with respect to the acoustic signal output device 20 is the D2 direction.

As illustrated in these figures, it can be seen that sound leakage can be adjusted by the size and shape of the cutout portion 231b.

Note that in addition to the sound holes 131b, the vertically long cutout portion 231b-LN that opens the inside of the reflector 13 to the outside may be provided on a part of the open end 130 side of the reflector 13.

### Third Embodiment

In the first embodiment, the first and second modification examples, and the second embodiment, a part of the reflector 13 may be used as a diaphragm of a driver unit (second driver unit). Thus, the size can be reduced as a whole. A specific example will be described below.

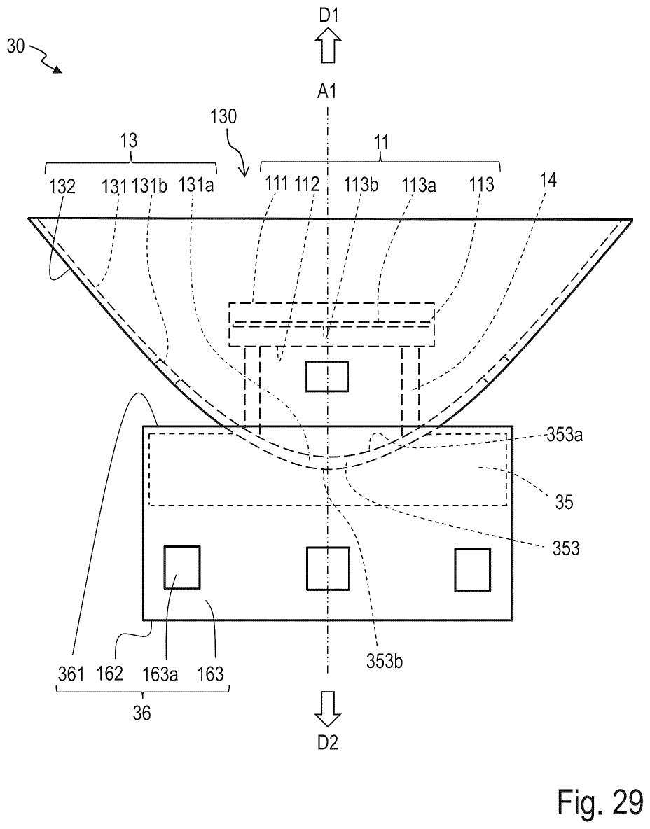

An acoustic signal output device 30 illustrated in FIG. 29 includes a concave reflector 13 that has a rotational paraboloid or a surface approximate to the rotational paraboloid inside, driver units 11 and 35 (a speaker driver unit and a driver) that convert an output signal output from a reproduction device into an acoustic signal and output the acoustic signal, a housing 36 that accommodates the driver unit 35 therein, and a support portion 14 for disposing the driver unit 11 inside the reflector 13. However, the reflector 13 is disposed on a wall portion 361 side of the housing 36 in the D1 direction, and the bottom portion 131a (a part) of the reflector 13 also functions as a diaphragm 353 of the driver unit 35. That is, the driver unit 35 emits the acoustic signal AC3 (third acoustic signal) from (one) surface 353a on the D1 direction side to the D1 direction side (one side) when the diaphragm 353 that is the bottom portion 131a of the reflector 13 vibrates, and emits the acoustic signal AC4 (fourth acoustic signal) from the other surface 353b to the D2 direction side (the other side) by the vibration. Thus, the size of the acoustic signal output device 30 in the D1-D2 direction can be reduced. Preferably, at least a part of the inner wall surface 131 of the reflector 13 is a rotational paraboloid or a surface approximating the rotational paraboloid, and this rotational paraboloid has a shape formed by rotating a parabola about the axis A1 (a specific axis), and the diaphragm 353 is the bottom portion 131a of the reflector 13 disposed on the axis A1 or near the axis A1. Thus, the sound pressure of the acoustic signal AC3 emitted from the open end 130 of the reflector 13 is axially symmetric to or substantially axially symmetric to the axis A1. Furthermore, it is desirable that one or a plurality of the sound holes 131b (reflector sound holes) are provided at positions excluding the diaphragm 353 of the reflector 13. Thus, the acoustic signals AC3 and AC4 having high sound pressures can be emitted from the diaphragm 353.

Note that FIG. 29 illustrates an example in which the driver unit 11 is not accommodated in the housing 12. However, the driver unit 11 (first driver unit) may be accommodated in a housing 12 (first housing) different from the housing 36 (second housing), and the housing 12 accommodating the driver unit 11 may be disposed inside the reflector 13 in this manner (refer to the second modification example of the first embodiment).

### Other Modification Example

Note that the present invention is not limited to the above-described embodiments. For example, in the first and second embodiments and the modification examples thereof described above, an example in which the bottom portion 131a side of the reflector 13 is fixed to the wall portion 161 of the housing 16 has been described. However, the bottom portion 131a side of the reflector 13 may be integrated with the wall portion 161 of the housing 16.

Furthermore, it is desirable that the driver unit 11 is disposed at or near the focal point of the rotational paraboloid of the reflector 13, but the driver unit 11 may be disposed at other positions. For example, the driver unit 11 may be attached to the bottom portion 131a side of the reflector 13.

Furthermore, the reflector 13 may have a horn shape or other shapes.

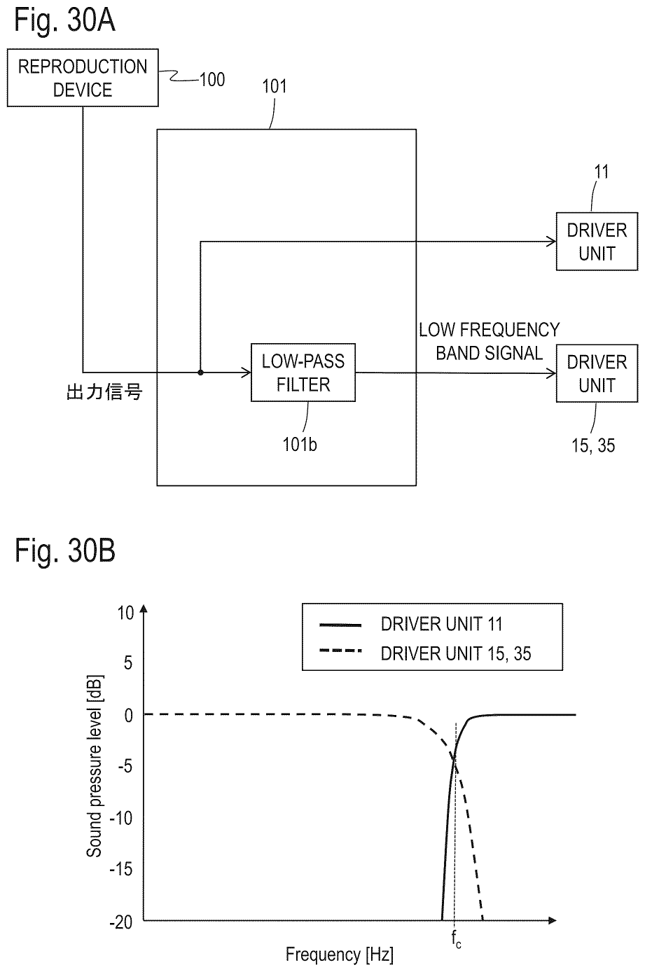

In the above-described embodiments and the modification examples thereof, the high-pass filter 101a may be omitted from the signal separation device 101 illustrated in FIG. 9A. Since the acoustic signals AC1 and AC2 emitted from the driver unit 11 are likely to be canceled out by mutual interference in the band on the medium-low frequency side, the sound pressure levels on the medium-low frequency side in the acoustic signal AC1 and the acoustic signal AC2 at the measurement point decrease. On the other hand, since the acoustic signals AC1 and AC2 do not sufficiently cancel out each other on the high-frequency side, the sound pressure levels on the high-frequency side in the acoustic signal AC1 and the acoustic signal AC2 at the measurement point are high. This feature serves a role equivalent to that of the high-pass filter. Therefore, even when the high-pass filter 101a is omitted from the signal separation device 101, the sound pressure levels in the acoustic signal AC1 and the acoustic signal AC2, measured at the measurement point, are suppressed on the medium-low frequency side and are not suppressed so much on the high-frequency side (FIG. 30B). This effect is particularly remarkable in a case where the driver unit 11 is accommodated inside the housing 12 provided with the sound holes 121a and 123a as described above (for example, the second modification example of the first embodiment). Therefore, in particular, in a case where the driver unit 11 is accommodated inside the housing 12 provided with the sound holes 121a and 123a, even when the high-pass filter 101a is omitted, the influence on the characteristics is small.

In the case of such a configuration, the output signal output from the reproduction device 100 is input to the signal separation device 101, and the signal separation device 101 branches the input output signal into two. The branched output signals are input to the driver unit 11 and the low-pass filter 101b, respectively. The driver unit 11 emits the acoustic signal AC1 to the D1 direction side and emits the acoustic signal AC2 to the D2 direction side on the basis of the input output signal. The low-pass filter 101b attenuates the high-frequency side of the input output signal to obtain and output a low frequency band signal. The low frequency band signal is input to any of the driver unit 15 or 35 of the acoustic signal output devices 10 to 30, and the driver unit 15 or 35 emits the acoustic signal AC3 to the D1 direction side and emits the acoustic signal AC4 to the D2 direction side.

### REFERENCE SIGNS LIST

10, 20, 30 Acoustic signal output device
11, 15, 35 Driver unit
12, 16, 36 Housing
13 Reflector
113, 153, 353 Diaphragm
130 Open end
231b Cutout portion
101a High-pass filter
101b Low-pass filter
131a Bottom portion
131b, 161a, 163a Sound hole

1. An acoustic signal output device comprising:
a concave reflector that has a rotational paraboloid or a surface approximate to the rotational paraboloid inside; and
a first driver that is disposed inside the reflector,
wherein an acoustic signal emitted from the first driver to one side is a first acoustic signal, an acoustic signal emitted from the first driver to the other side is a second acoustic signal, and
in a case where the first acoustic signal is emitted from one side of the first driver and the second acoustic signal is emitted from the other side of the first driver, the acoustic signal output device is designed such that
an attenuation rate of the first acoustic signal at a second point that is based on a predetermined first point where the first acoustic signal arrives and is more distant from the acoustic signal output device than the first point
is less than or equal to
a predetermined value smaller than an attenuation rate caused by air propagation of an acoustic signal at the second point based on the first point, or
an attenuation amount of the first acoustic signal at the second point based on the first point
is larger than or equal to
a predetermined value larger than an attenuation amount caused by the air propagation of the acoustic signal at the second point based on the first point.

2. The acoustic signal output device according to claim 1,
wherein the first driver is disposed at or near a focal point of the rotational paraboloid.

3. The acoustic signal output device according to claim 1,
wherein the rotational paraboloid has a shape formed by rotating a parabola about a specific axis,
the first driver emits the first acoustic signal to one side of the first driver along the axis and emits the second acoustic signal to the other side of the first driver along the axis, and
the reflector is provided with one or a plurality of reflector sound holes.

4. The acoustic signal output device according to claim 3,
wherein the reflector sound hole is disposed on the other side of the first driver or in a vicinity of the other side of the first driver.

5. The acoustic signal output device according to claim 1, further comprising:
a second driver; and
a second housing that accommodates the second driver therein,
wherein the second housing is disposed outside the reflector,
an acoustic signal emitted from the second driver to one side is a third acoustic signal, an acoustic signal emitted from the second driver to the other side is a fourth acoustic signal,
a wall portion of the second housing is provided with one or a plurality of third sound holes for leading out the third acoustic signal to an inside of the reflector and one or a plurality of fourth sound holes for leading out the fourth acoustic signal to an outside of the reflector, and
in a case where the first acoustic signal is emitted from one side of the first driver, the second acoustic signal is emitted from the other side of the first driver, the third acoustic signal is emitted from one side of the second driver, and the fourth acoustic signal is emitted from the other side of the second driver, the acoustic signal output device is designed such that
an attenuation rate of the first acoustic signal and an attenuation rate of the third acoustic signal at the second point based on the first point
are less than or equal to
a predetermined value smaller than an attenuation rate caused by air propagation of an acoustic signal at the second point based on the first point, or
an attenuation amount of the first acoustic signal and an attenuation amount of the third acoustic signal at the second point based on the first point
are larger than or equal to
a predetermined value larger than an attenuation amount caused by air propagation of an acoustic signal at the second point based on the first point.

6. The acoustic signal output device according to claim 5,
wherein a frequency band of a reproduced acoustic signal is divided into a high frequency band and a low frequency band,
the first driver emits an acoustic signal on the high frequency band side in the reproduced acoustic signal, and
the second driver emits an acoustic signal on the low frequency band side in the reproduced acoustic signal.

7. The acoustic signal output device according to claim 6,
wherein an opening area of an open end of the reflector is S₁, an area of a surface on the one side of the first driver is S₂, a length from the surface on the one side of the first driver to the open end of the reflector is S₃, and c is a sound speed, and
a cross frequency between the high frequency band and the low frequency band is lower than a frequency represented by Equation below.
$$\begin{matrix}[ Math . 6 ] & \\ {f}_{c} \approx \frac{2.3 c}{4 π {S}_{3}} {log}_{10} \frac{{S}_{2}}{{S}_{1}} & \end{matrix}$$

8. The acoustic signal output device according to claim 3, further comprising:
a second driver; and
a second housing that accommodates the second driver therein,
wherein the second housing is disposed outside the reflector,
the rotational paraboloid has a shape formed by rotating a parabola about a specific axis,
an acoustic signal emitted from the second driver to one side along the axis is a third acoustic signal, an acoustic signal emitted from the second driver to the other side along the axis is a fourth acoustic signal,
the first driver emits the first acoustic signal to one side of the first driver along the axis and emits the second acoustic signal to the other side of the first driver along the axis,
a wall portion of the second housing is provided with one or a plurality of third sound holes for leading out the third acoustic signal to an outside of the reflector and one or a plurality of fourth sound holes for leading out the fourth acoustic signal to an outside of the reflector,
the third sound holes are connected to at least some of the reflector sound holes,
the reflector hole connected to the third sound hole or a center for a plurality of the reflector holes connected to the third sound holes is disposed on the axis or near the axis, the first driver is disposed on the axis or near the axis, and
in a case where the first acoustic signal is emitted from one side of the first driver, the second acoustic signal is emitted from the other side of the first driver, the third acoustic signal is emitted from one side of the second driver, and the fourth acoustic signal is emitted from the other side of the second driver, the acoustic signal output device is designed such that
an attenuation rate of the first acoustic signal and an attenuation rate of the third acoustic signal at the second point based on the first point
are less than or equal to
a predetermined value smaller than an attenuation amount caused by air propagation of an acoustic signal at the second point based on the first point, or
an attenuation amount of the first acoustic signal and an attenuation amount of the third acoustic signal at the second point based on the first point
are larger than or equal to
a predetermined value larger than an attenuation amount caused by the air propagation of the acoustic signal at the second point based on the first point.

9. The acoustic signal output device according to claim 1, further comprising:
a first housing that accommodates the first driver therein;
a second driver; and
a second housing that accommodates the second driver therein,
wherein the first housing is disposed inside the reflector,
the second housing is disposed outside the reflector,
an acoustic signal emitted from the second driver to one side is a third acoustic signal, an acoustic signal emitted from the second driver to the other side is a fourth acoustic signal,
a wall portion of the first housing is provided with one or a plurality of first sound holes for leading out the first acoustic signal to an inside of the reflector and one or a plurality of fourth sound holes for leading out the second acoustic signal to the inside of the reflector,
a wall portion of the second housing is provided with one or a plurality of third sound holes for leading out the third acoustic signal to the inside of the reflector and one or a plurality of fourth sound holes for leading out the fourth acoustic signal to an outside of the reflector, and
in a case where the first acoustic signal is emitted from one side of the first driver, the second acoustic signal is emitted from the other side of the first driver, the third acoustic signal is emitted from one side of the second driver, and the fourth acoustic signal is emitted from the other side of the second driver, the acoustic signal output device is designed such that
an attenuation rate of the first acoustic signal and an attenuation rate of the third acoustic signal at the second point based on the first point
are less than or equal to
a predetermined value smaller than an attenuation rate caused by air propagation of an acoustic signal at the second point based on the first point, or
an attenuation amount of the first acoustic signal and an attenuation amount of the third acoustic signal at the second point based on the first point
are larger than or equal to
a predetermined value larger than an attenuation amount caused by air propagation of an acoustic signal at the second point based on the first point.
